(19) United States
(12) Patent Application Publication
(10) Pub. No.: US 2006/0135137 A1
(43) Pub. Date: Jun. 22, 2006

(54) System and method for providing integrated communication id

(76) Inventor: Eun Young Chung, Seoul (KR)

Correspondence Address: MCDERMOTT WILL & EMERY LLP;ATTN: INTELLECTUAL PROPERTY DEPTARTMENT, 28 STATE STREET, BOSTON, MA, 02109, US

(21) Appl. No.: 10/518,821

(22) PCT Filed: Nov. 29, 2003
(86) PCT No.: PCT/KR03/02614

§ 371 Date: Oct. 3, 2005

(30) Foreign Application Priority Data
Nov. 29, 2002 (KR) 10-2002-0075476
Nov. 27, 2003 (KR) 10-2003-0085232

(51) Int. Cl. H04M 3/42

(52) U.S. Cl. 455/415

(57) ABSTRACT

The present invention discloses a system and method for providing an integrated communication ID and it is an object of the present invention to allow a caller to connect to a receiver's a variety of communication equipments conveniently, with only an integrated communication ID of the receiver being perceived, by allocating a single, inherent communication ID to multiple users and managing multiple directory communication equipment data to enable call connection. In the application of the present invention, with only the integrated communication ID of the receiver being perceived, the caller can execute connection to the corresponding receiver's mobile communication terminal devices, wired terminal devices, facsimiles, homepages and the like by relaying, and an unspecific, third party can access conveniently to a variety of public open information using one integrated communication ID. By this, there is no need to memorize a wide variety of number including various telephone numbers, homepage URLs, mail IDs, messenger IDs and the like among the flood of information.

### TECHNICAL FIELD

The present invention relates to a system and method for providing an integrated communication ID, and more particularly, to a system and method for providing an integrated communication ID which allocate a single individual integrated communication ID to a respective user so that an unspecified third person can access to the user's various kinds of communication means (such as a mobile communication terminal, facsimile, wire telephone, homepage, e-mail, web phone, messenger and the like).

### BACKGROUND ART

With a recent development in information communication technology, the development of information provision technology providing information about various fields to multiple subscribers via at least one host server over a remote data communication network are actively in progress.

Based upon this, peripheral technology, such as cache memory expansion technology for providing precise information to subscribers more rapidly, and information screening technology and compression technology capable of approaching to the taste and preference of subscribers more conveniently, are being developed. Accordingly, the development of various contents and their solutions are also being accelerated.

Additionally, as mobile communication terminals have been spread explosively along with a dramatic enhancement in mobile communication technology, most people, young, and old, men and women all alike, carry a cellular phone or PCS phone and execute a voice call and various data communications. Meanwhile, owing to the improvement of computer communication, the switching of various kinds of documents by e-mail and the transmission and reception of moving pictures or image data are generally used by multiple users. Also, users and companies actively prepare and have their own homepages.

Recently, a messenger program, a short messaging system manufactured by Microsoft, has been come into the market and is being used by many users. The messenger program is a program capable of sending and receiving a short message to and from a desired party in a state that the IP value of a PC is registered, and it can deliver a short message in real time in an executed state unlike e-mail.

Furthermore, in a large number of financial firms, internet banking is prevalent, by which a user connects to a banking server by way of a computer terminal, passes through a user identification procedure and executes banking transactions such as the transfer to a desired account and the setting of various kinds of automatic transfers.

Resultantly, in such communication-based environment, users have to memorize a great number of IDs and passwords for authenticating access means, and, besides, have to memorize other people's e-mail address, homepage address, mobile communication terminal number, wire telephone number, office telephone number, facsimile number, ID and password for e-mail access, other various numbers such as vehicle number, domain address, ID and the like.

For an example, in a case that a specific user wants to make a phone call to a specific third person by using a mobile communication terminal, the user attempts a phone call by entering a mobile communication number printed on the name card given by the corresponding third person. But, in case that the call is unavailable, the user has to re-attempt a phone call by entering an office telephone number printed on the name card, which is very inconvenient.

Moreover, in case of wanting to access to the homepage of a specific person or send a mail, there is no system at all like a telephone number messaging system 114 in Korea that provides information on the corresponding homepage or mail address, which is also very inconvenient.

Additionally, in order that a user can check its own e-mail, the user has to check whether an e-mail has been received or not by connecting to a specific mail server and entering an ID and a password. Also, in case of wanting to know whether money is received on its account, the user has to close the access to the mail server, access to a specific banking server, enter an ID and password again and then check whether money is received. Accordingly, there is an inconvenience that the user has to open and close the window too often.

Further, in case of a web phone, that is, a voice call (so-called dial pad) through a data communication network of computer terminals, this requires no user telephone number of each of the computer terminals and, thus, costs low, has no risk of disconnection because the internet network is used, and is continuously improved in quality. However, conventionally, there was a problem that such web phone also has to be allocated a specific number. Besides, there is a limitation on the spread of web phones due to the problem that the user has to memorize all the web phone numbers of desired called parties when the specific number is allocated,

Further, under the condition that a facsimile should be quickly sent to a specific person from the outside, there is an inconvenience that a user has to make a phone call to the specific person and ask a facsimile number. Also, in a case that a user makes a phone call to a specific company through a telephone number messaging system 114, there is a problem that the user has to attempt a connection continually until a desired person in charge of a desired team is connected through an extension. Accordingly, the company suffers an enormous loss from the waste of cost and time, and the caller who wants to talk over the phone with the corresponding person in charge must wait for a long time, which is very inconvenient.

### DISCLOSURE OF THE INVENTION

It is an object of the present invention to provide a system and method for providing an integrated communication ID which allow a user to have a communication ID-related information registered by a specified third person displayed by utilizing a mobile communication terminal.

It is another object of the present invention to provide a system and method for providing an integrated communication ID which allocate a single individual integrated communication ID to a respective user so that an unspecified third person can access to the user's various kinds of communication means (such as a mobile communication terminal, facsimile, wire telephone, homepage, e-mail, web phone, messenger and the like).

It is yet another object of the present invention to provide a system and method for providing an integrated communication ID which enables a respective user to register and modify directory information on a single integrated communication ID so that an unspecified third person can access to the user's various kinds of communication means (such as a mobile communication terminal, facsimile, wire telephone, homepage, e-mail, web phone, messenger and the like).

It is still another object of the present invention to provide a system and method for providing an integrated communication ID which provide directory information for registered integrated communication IDs so that an unspecified third person can access to a user's various kinds of communication means by utilizing a wire telephone terminal.

It is yet still another object of the present invention to provide a system and method for providing an integrated communication ID which provide directory information for registered integrated communication IDs so that an unspecified third person can access to a user's various kinds of communication means by utilizing a web phone.

It is yet still another object of the present invention to provide a system and method for providing an integrated communication ID which can establish a call connection in real time to various kinds of communication equipment having other people's integrated communication ID by voice inputting utilizing a wireless communication terminal and which allows to provide various directory information linked with the integrated communication ID.

It is yet still another object of the present invention to provide a system and method for providing an integrated communication ID which is provided with a remote server linked with a banking server so as to instruct a paying-in/paying-out command by utilizing a mobile communication terminal and which allows to conduct a safe banking transaction by mounting visual accounts for respective users at the remote server.

It is yet still another object of the present invention to provide a system and method for providing an integrated communication ID which allows a user to easily utilize the corresponding integrated communication ID by registering, managing and providing integrated communication IDs so as to enable a classification into acquaintance and business and a redundancy allocation by utilizing a basic integrated communication ID, a relational integrated communication ID and a local integrated communication ID classified according to respective integrated communication IDs.

It is yet still another object of the present invention to provide a system and method for providing an integrated communication ID which allows to form variety of communities according to groups through the internet network by automatically allocating an individual IP address to the computer terminal of each individual user and providing a downloadable and installable exclusive application capable of operating with the IP address and the integrated communication ID in conjunction with each other.

To achieve the above objects, there is provided a system for providing an integrated communication ID according to the present invention, comprising: a caller terminal which allows an unspecified third person perceiving an integrated communication ID of a callee to generate various communication signals and input signals; an integrated communication ID provision server which stores various communication target connection numbers, vehicle number, children's real name and the like as directory information, provides a single individual integrated communication ID commonly designating the above information to manage the same so as to provide other connection number and readable information to an unspecified third person perceiving the integrated communication ID, and designates a connection route in response to a route query request of various kinds of interchange servers; and an interchange server which is connected so as to able to scan the database of the integrated communication ID provision server, executes a query request for a route to the integrated communication ID provision server according to a connection request signal from the caller terminal and executes a connection attempt to a connection target terminal according to an answer signal.

Preferably, the communication target connection number is a mobile communication terminal, a facsimile, a wire telephone, a homepage, e-mail, a web phone, a messenger and the like.

Preferably, the caller terminal is communication equipment capable of voice communication and data communication, including a mobile communication terminal, a wire telephone terminal and a personal computer terminal.

Preferably, the caller terminal has inside a code conversion algorithm installed therein for automatically converting an integrated communication ID composed of multi-language characters entered by a user into a connection code of a numeric string receivable by a switch and a base station.

Preferably, the code conversion algorithm is either the allocation of a connection code for respective characters or the allocation of a connection code for respective words.

Preferably, the interchange server includes at least one of a base station and a switch which are a repeater of a wireless communication network, an intelligent network switch, a local switch which is a repeater of a wire communication network, a toll switch, a connection switch, various route servers and gateways which are repeaters of wire/wireless web networks, and a WAP gateway.

Preferably, the integrated communication ID provision server further comprises a database scannably storing personal information of a user who is allocated an integrated ID, integrated communication ID information allocated individually to respective users and open information opened by the user such as various communication equipment and homepage information, e-mail information, vehicle information, children's real name and the like.

Preferably, an information display number individually representing various information (cellular phone number, home telephone number, office telephone number, homepage, e-mail) stored in the directory information for respective integrated communication IDs is predetermined to be a characteristic number or the like between the integrated communication ID provision server and the user.

Preferably, the integrated communication ID is composed of at least one of various kinds of characters, specific characters, numeric characters, various kinds of patterns and image data.

Preferably, in the case that the caller terminal is a mobile communication terminal, an integrated communication ID information and character data to be transmitted are simultaneously entered into the same screen so that the integrated communication ID provision server can recognize them separately.

Preferably, a specific character or symbol representing the beginning of a text is interposed between the integrated communication ID information and the character data.

In an aspect of the present invention, there is provided a method for providing an integrated communication ID individually allocated to enable a real time connection and a real time information reading by commonly designating a connection information of various connectable communication means and a various opened information by means of a server providing the integrated communication ID and an interchange server, the method comprising the steps of: multiple users' connecting to a PC or the integrated communication ID provision server; a user' registering an individual integrated communication ID and its low-order information; performing communication connection by utilizing an integrated communication ID of another user; and performing the reading of the opened low-order information by utilizing an integrated communication ID of another user.

Preferably, the step of a user' registering an individual integrated communication ID and its low-order information comprises the steps of: multiple users' connecting to a PC or the integrated communication ID provision server; retrieving whether an integrated communication ID desired to be registered by the user is registered or not; requesting for the registration of the corresponding integrated communication ID if the corresponding integrated communication ID is not redundant; and selecting which information to be opened among the directory information (home telephone number, office telephone number, homepage information, facsimile number, e-mail information, vehicle information, children's real name and the like) which is the low-order information of the registered integrated communication ID.

Preferably, the step of performing communication connection by utilizing an integrated communication ID of another user comprises the steps of: a certain user's attempting a connection by entering a connection-desired integrated communication ID of a specified third person and an information representing the communication target by utilizing a communication terminal; the interchange server's scanning the information issued from the communication terminal of the corresponding user in conjunction with the integrated communication ID provision server; the interchange server's executing a query request for the corresponding integrated communication ID to the integrated communication ID provision server; the integrated communication ID provision server's providing the corresponding integrated communication ID and a connectable communication equipment connection number based on the communication target information; and the interchange server's receiving the communication equipment connection number and malting a call connection between both parties.

Preferably, the method of present invention further comprises the step of sending a change information to the registrant registered in the integrated communication ID provision server according to the user's selection if the integrated communication ID of the corresponding user is changed.

Preferably, the method of present invention further comprises the steps of: a user's entering an integrated communication ID of a call connection target person by utilizing a wire/wireless terminal; converting the integrated communication ID of the call connection target person by utilizing a code conversion algorithm installed at the wire/wireless terminal of the corresponding user; generating a frequency signal corresponding to the connection code; receiving the frequency signal via a switch or a local/toll switch; transmitting the corresponding frequency to an intelligent network switch; the intelligent network switch's restoring the connection code by utilizing the frequency information to transmit the same to the integrated communication ID provision server; extracting the actual telephone number of the user having the corresponding connection code from the integrated communication ID provision server; transmitting the actual telephone number to the intelligent network, the switch and a base station to attempt a call connection; converting the connection code to restore the integrated communication ID of the originating user; and soft copying the restored integrated communication ID of the originating user.

Preferably, the step of extracting the actual telephone number of the connection target person the integrated communication ID provision server further comprises the step of combining a specific phrase registered by the originating user so as to be included in a call connection data packet along with the integrated communication ID of the originating user.

In another aspect of the present invention, there is provided a method for providing an integrated communication ID, which has various communication equipment and its low-order information registered and further comprises a voice ID announcing apparatus consisting of a voice perception apparatus and an ARS apparatus, comprising the steps of executing a call connection to the integrated communication ID provision server by utilizing a short-cut key or a representative telephone number; entering an integrated communication ID in voice; converting voice data into character data and extracting the corresponding connection code and the actual telephone number; transmitting the connection code and the actual telephone number to a repeater; and the repeater's establishing a call connection between the terminal of both users.

In yet another aspect of the present invention, there is provided a system for providing an integrated communication ID, comprising: a caller wire telephone terminal for allowing an unspecified third person perceiving the integrated communication ID of a callee to generate various kinds of communication signals and input signals; an integrated communication ID provision server which provides an integrated communication ID to the callee, provides opened information of the corresponding integrated communication ID to the caller, who is an unspecified third person, as the low-order information of the integrated communication ID, and designates a connection route so as to enable a real time communication connection, and which is constructed of a voice perception apparatus and a voice ID announcing apparatus capable of recognizing an integrated communication ID and generating various answer signals; an interchange server which executes a signal interchanging so as to be able to transmit data to the integrated communication ID provision server according to a connection request signal from the wire telephone terminal; and a callee terminal which executes a call connection by way of the integrated communication ID provision server according to the integrated communication ID information entered via the caller wire telephone terminal and according to a request for connection to the communication equipment target.

Preferably, the integrated communication ID provision server further comprises a database with storage areas allocated to respective integrated communication Ids so as to store various data sent and received between a caller terminal and a callee terminal.

Preferably, the method of the present invention further comprises the steps of: an unspecified third person's connecting to the integrated communication ID provision server via various kinds of terminals; entering a specific directory information; inverse-scanning the telephone terminal of the owner of the corresponding directory information; attempting a call connection to the owner of the corresponding directory information so as to enable a communication connection to the owner.

Preferably, the integrated communication ID includes a basic integrated communication ID allocated individually, a relational integrated communication ID allocated redundantly in unit of groups and a local integrated communication ID allocated redundantly according to a regional unit.

Preferably, the caller terminal has the basic input mode for entering a basic integrated communication ID, the relational integrated communication ID input mode and the local integrated communication ID input mode all individually and optionally configured.

Preferably, the integrated communication ID provision server has inside a database configured therein to have a structure in which relational integrated communication ID data and local integrated communication ID data are linked with each other based on the database storing basic integrated communication IDs.

### BRIEF DESCRIPTION OF THE DRAWINGS

FIG. 1 is a block diagram illustrating a schematic configuration of a system for providing an integrated communication ID according to a first embodiment of the present invention;

FIG. 2a is a table chart illustrating directory information for respective communication IDs registered to the system for providing an integrated communication 1D according to the first embodiment of the present invention;

FIG. 2b is a view illustrating a setting status of a primary directory information for respective communication IDs registered in the system for providing an integrated communication ID according to the first embodiment of the present invention;

FIG. 3 is a data chart showing a data flow of the system for providing an integrated communication ID according to the first embodiment of the present invention;

FIG. 4 is a data chart showing another data flow of the system for providing an integrated communication ID according to the first embodiment of the present invention;

FIGS. 5a to 5e are flow charts showing a signal flow of the system for providing an integrated communication ID according to the first embodiment of the present invention;

FIGS. 6a to 6d are network configuration views fully illustrating a network configuration of the system for providing an integrated communication ID according to the first embodiment of the present invention;

FIGS. 7a and 7b are views illustrating an originating signal of a terminal in the system for providing an integrated communication ID according to the first embodiment of the present invention;

FIGS. 8a, 8b and 8c are views illustrating a signal translation procedure in the system for providing an integrated communication ID according to the first embodiment of the present invention;

FIG. 9 is a block diagram illustrating various integrated communication IDs provided by the system for providing an integrated communication ID according to a second embodiment of the present invention and a telephone number extraction status in their data groups;

FIG. 10 is a status view illustrating a call connection status utilizing a basic integrated communication ID and a relational integrated communication ID provided by the system for providing an integrated communication ID according to the second embodiment of the present invention;

FIG. 11 is a view fully illustrating a call connection network configuration utilizing a local integrated communication ID of the system for providing an integrated communication ID according to the second embodiment of the present invention;

FIG. 12 is a status view illustrating a call connection status utilizing a local integrated communication ID of the system for providing an integrated communication ID according to the second embodiment of the present invention;

FIG. 13 is a view fully illustrating a network configuration of the system for providing an integrated communication ID according to a third embodiment of the present invention;

FIG. 14 is a block diagram illustrating a schematic configuration of a system for providing an integrated communication ID according to a fourth embodiment of the present invention;

FIG. 15 is a view showing a data flow of the system for providing an integrated communication ID according to the fourth embodiment of the present invention;

FIG. 16 is a view showing another data flow of the system for providing an integrated communication ID according to the fourth embodiment of the present invention;

FIG. 17 is a block diagram illustrating a schematic configuration of a system for providing an integrated communication ID according to a fifth embodiment of the present invention;

FIG. 18 is a block diagram illustrating a schematic configuration of a system for providing an integrated communication ID according to a sixth embodiment of the present invention;

FIG. 19 is a block diagram illustrating a configuration in which an IP database is included in the system for providing an integrated communication ID according to the sixth embodiment of the present invention;

FIG. 20 is a view illustrating a web exclusive application installation and a data communication status using the application in the system for providing an integrated communication ID according to the sixth embodiment of the present invention; and

FIG. 21 is a view illustrating a soft copy status of the web exclusive application of the system for providing an integrated communication ID according to the sixth embodiment of the present invention.

### BEST MODE FOR CARRYING OUT THE INVENTION

Hereinafter, a first embodiment of the present invention will be described in detail with reference to the accompanying drawings.

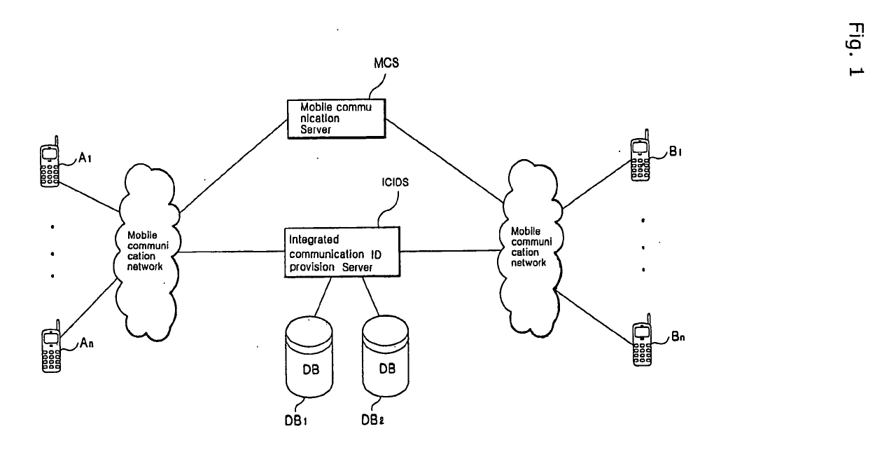

FIG. 1 is a block diagram illustrating a schematic configuration of a system for providing an integrated communication ID according to a first embodiment of the present invention.

Referring to this, the system for providing an integrated communication ID according to the first embodiment can allocate a single, integrated communication ID to respective users so that an unspecified third person can access to various kinds of communication means (such as a mobile communication terminal, facsimile, wire telephone, homepage, e-mail, web phone, messenger, etc.). In the present invention, an exemplified integrated communication ID (multi-communication ID) is a representative ID of multiple directory information (such as mobile information terminal number, facsimile number, wire telephone number, homepage URL, e-mail ID, web phone number, messenger ID, . . . and the like) allocated so that an unspecified third person can access by way of a variety of communication networks.

That is to say, when a certain user enters an integrated communication ID of a specific third person through the system for providing an integrated communication ID of the first embodiment, the user can connect in real time to the mobile communication terminal, facsimile, wire telephone, homepage, e-mail, web phone, messenger, etc. of the corresponding specific third person according to whether the directory information of the corresponding integrated communication ID is open to the public or not. For instance, in case of having to access to the homepage of a specific third person, the user who knows only the mobile communication terminal number of the corresponding third person can be provided with the homepage URL of the user of the corresponding number without talking with him or her.

In addition, it is also possible to open the directory information corresponding to a user's own integrated communication ID only to specific people through the system for providing an integrated communication ID of the first embodiment of the present invention. That is, the partial interruption function is added so as to provide the user's own directory information only in a case that a plurality of people having an integrated communication ID registered by the user connects, thereby protecting his or her privacy.

In the system for providing an integrated communication ID according to the first embodiment of the present invention, configured is a integrated communication ID provision server ICIDS for providing respective users an integrated communication ID as a representative name by which a multiplicity of users connect to acquire or access to information on various kinds of communication means.

The integrated communication ID provision server ICIDS allocates an integrated communication ID to respective users, and makes various communication information of the corresponding users into a database of directory information for respective integrated communication IDs. Thus, the integrated communication ID provision server ICIDS is provided with a first database DB1 storing personal information of a corresponding user and a second database DB2 storing integrated communication ID information for respective users and information for the users' respective communication IDs.

The first database DB1 and the second database DB2 are constructed in a manner to be capable of multi-scanning. Thus, in a case that a certain user accesses to the integrated communication ID provision server ICIDS using mobile communication terminals A1˜An and then requests for a directory information on a specific integrated communication ID, the second databases DB2 is allowed to execute a real time scanning using the corresponding integrated communication ID as a query request information. At this time, the integrated communication ID provision server ICIDS scans in which table the corresponding multi-communication ID exists and reads out the directory information (various communication information) according to the corresponding integrated communication ID from the scanned table information.

The query information from the mobile communication terminals A1˜An is firstly transmitted to a mobile communication server MCS. The mobile communication server MCS judges whether a request signal from the mobile communication terminals A1˜An is a call connection signal or a character data transfer signal. In the integrated communication ID provision server ICIDS, the second database DB2 is open to the mobile communication server MCS. Thus, the mobile communication server MCS executes an information retrieval of originating mobile communication terminals A1˜An, a request information from the corresponding mobile communication terminal and a retrieval of receiving mobile communication terminals B1˜Bn.

Therefore, the mobile communication server MCS judges whether a caller is a callable subscriber by scanning a constructed information of the mobile communication terminals A1˜An of the caller, and multi-scans the mobile communication terminals B1˜Bn of a callee. If the corresponding callee's number is not retrieved in the database of the mobile communication server MCS, a request for scanning is made whether the corresponding integrated communication ID exists in the integrated communication ID provision server ICIDS.

According to that scan request signal, the integrated communication ID provision server ICIDS scans in which table the corresponding integrated communication ID exists by scanning the second database DB2, and, if the integrated communication ID is scanned, it reads out and provides the corresponding directory information.

Preferably, a specific number is allocated according to an access target among the directory information, and, when the number is positioned on the front part of an integrated communication ID, the integrated communication ID provision server ICIDS is allowed to recognize which communication target information is requested.

For instance, if a certain user desires to make a call connection to the mobile communication terminals B1˜Bn of a specific user, a specific number letting the integrated communication ID provision server ICIDS to recognize that a connection target apparatus is a mobile communication terminal is entered and provided to the front part of the integrated communication ID, thereby enabling a more rapid communication connection.

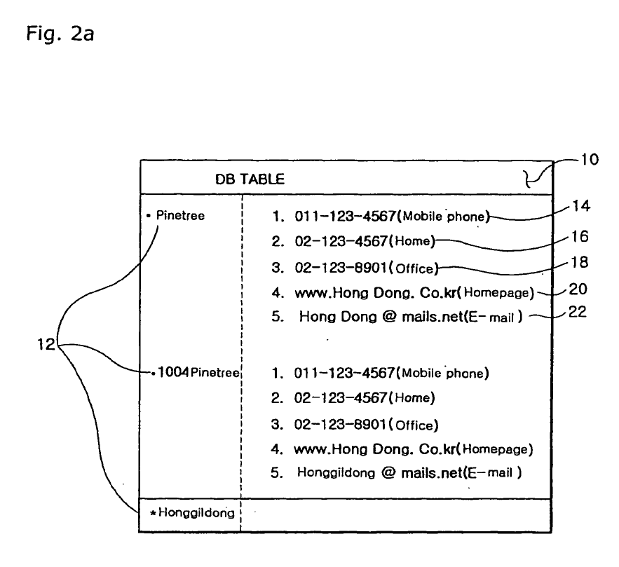

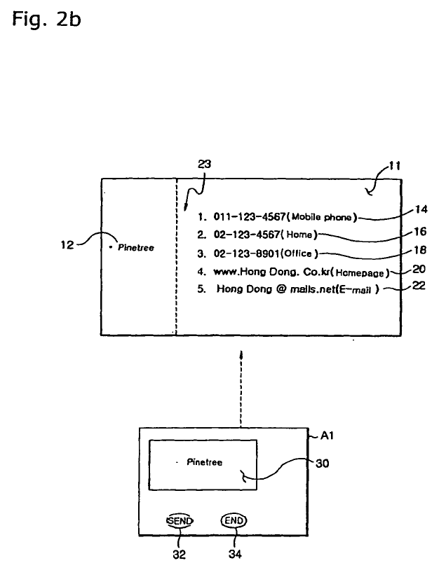

FIG. 2a is a table chart illustrating directory information for respective communication IDs registered to the system for providing an integrated communication ID according to the first embodiment of the present invention.

Referring to this, integrated communication IDs constructed in the database of the integrated communication ID provision server and a directory information for the respective integrated communication IDs are as shown in FIG. 2. As the integrated communication ID provision server ICIDS is located among various communication equipments, it can easily connect to various communication equipments of a user having a corresponding integrated communication ID through a single, specific integrated communication ID.

For this, a plurality of table charts 10 are configured in the second database DB2 of the integrated communication ID provision server ICIDS. And, according to a communication equipment (e.g., a mobile communication terminal, wire telephone terminal, PC . . . etc.) generating data, the integrated communication ID provision server ICIDS is connected to a repeating device (for example, various kinds of interchange servers, repeaters, route servers and the like) which the communication equipment initially connects to.

Therefore, in a table chart 10, directory information is classified and registered based on integrated communication IDs 12 (e.g., pinetree, 1004 pinetree, *honggildong*, . . . etc.) allocated by the integrated communication ID provision server ICIDS. At this time, the integrated communication IDs 12 can be freely made up of Korean alphabet, English alphabet, numeric characters, special characters, image data and moving image data according to the selection of a user. It is retrieved if an integrated communication ID 12 desired to be registered is identical to one of other users' integrated communication IDs 12 registered in advance in the order of registration like a kind of domain. As a result, if the integrated communication ID 12 desired to be registered is a characteristic one not identical to other users' integrated communication IDs.

One integrated communication ID 12 has a directory information that is to be registered for respective communication targets of various kinds according to a user's desire. As the directory information, can be registered a portable phone information 14 (e.g., 011-123-4567), a home telephone number 16 (e.g., 02-123-4567), an office telephone number 18 (e.g., 02-123-8910), a homepage information 20 (e.g., www.hongdong,co.kr), an e-mail information 22 (e.g., hongdong@mails.net), a vehicle number, children's names, a pet dog number, a children image information, . . . and the like.

At this time, the directory information which is a low-order information of the integrated communication ID 12 has to be allocated a specific number for respective communication equipments. For example, the portable phone information can be defined as No. 1, the home telephone number as No. 2, the office telephone number as No. 3, the homepage as No. 4, the e-mail as No. 5 and the like.

Additionally, the directory information registered according to the integrated communication ID 12 can be open to the public or not according to a user's desired, or only a specific information can be made not open to the public.

The allocation of a specific number to respective directory information is to allow a caller to rapidly connect to a callee, or to rapidly provide only the information requested by the callee. For instance, if the caller requests the integrated communication ID provision server ICIDS the homepage information of a callee having an integrated communication ID named ‘pinetree’ by utilizing the mobile communication terminals A1˜An, the caller transmits ‘4pinetree’ to the integrated communication ID provision server ICIDS.

Then, the integrated communication ID provision server ICIDS firstly scans the integrated communication ID (e.g., pinetree) among the information of the second database DB2, reads out the homepage information corresponding to ‘4’ among the directory information of the corresponding integrated communication ID (e.g., pinetree) and transmits them to the mobile communication terminals A1˜An of the corresponding caller. At this time, characteristic numbers (e.g., 1,2,3,4,5, . . . ) characteristic of respective access targets are not limited to numeric characters, but include various specific characters, general characters and the like.

FIG. 2b is a view illustrating a setting status of a primary directory information for respective communication IDs registered in the system for providing an integrated communication ID according to the first embodiment of the present invention.

Referring to this, a plurality of table charts 10 are configured in the second database DB2 of the integrated communication ID provision server ICIDS. And, according to a communication equipment (e.g., a mobile communication terminal, wire telephone terminal, PC . . . etc.) generating data, the integrated communication ID provision server ICIDS is connected to a repeating device (for example, various kinds of interchange servers, repeaters, route servers and the like) which the communication equipment initially connects to.

At this time, an information setting can be made to the integrated communication ID provision server ICIDS by setting as a communication equipment for primary reception service one (e.g., a wire telephone at home) of communication equipments (e.g., a mobile communication terminal, a wire telephone terminal, a PC, . . . , etc.) connectable relative to a user's integrated communication ID (e.g., pinetree 12) allocated in advance

That is, a certain specific user can set a desired primary communication equipment by connecting to the integrated communication ID provision server ICIDS using the mobile communication terminals A1˜An or a PC (not shown). For instance, if the corresponding user sets a home wire telephone as a primary communication equipment, the user can confirm his or her primary communication equipment information by connecting to the integrated communication ID provision server ICIDS by using a PC or mobile communication terminals A1˜An.

Additionally, in a case that an unspecified third person desires to make a call with a specific user, for example, an user with an integrated communication ID ‘pinetree’ by using mobile communication terminals A1˜An or other communication equipments, the unspecified third person enters only ‘pinetree’, the integrated communication ID of a callee, in his or her mobile communication terminals A1˜An and then operates a snd button 32.

Then, the integrated communication ID provision server ICIDS scans what the telephone number of the corresponding user who registered the integrated communication ID ‘pinetree’ is. At this time, the integrated communication ID provision server ICIDS judges whether the corresponding callee user registered a primary communication equipment, and, if the corresponding user registered a home telephone number (e.g., 02-123-4567) as a primary communication equipment, the integrated communication ID provision server ICIDS extracts the corresponding telephone number data to allow a call connection. The procedure of attempting a call connection by extracting a telephone number from the integrated communication ID provision server ICIDS through an intelligent network will be described later.

In short, only when a caller enters an integrated communication ID (e.g., pinetree) of a callee and transmits one of connectable communication equipments of various kinds by using the corresponding integrated communication ID, the integrated communication ID provision server ICIDS can recognize to which communication equipment of a callee having a specific integrated communication ID the corresponding caller is to be connected, and then can execute a call connection. But, in the present invention, since the callee can register the setting of a primary communication equipment in the integrated communication ID provision server ICIDS as described above, the caller can achieve the object of maling a phone call to the callee and the callee can concentrate his or her use on any one of communication equipments (e.g., home telephone) as the user desires while taking his or her circumstance into consideration as much as possible.

In the above described method, the access of an unspecified third person can be permitted or not permitted relative to other communication equipments in addition to the communication equipment (e.g., home telephone) set as a primary communication equipment by the callee. That is, in a case that an unspecified third person attempts a connection to a speech path or other data communication paths using his or her integrated communication ID (e.g., pinetree), the callee can establish a setting in such a manner that only a primarily set communication equipment (e.g, home telephone) is accessible and other communications apparatuses are not accessible. On the contrary, the callee can establish a setting in such a manner that a certain specific communication equipment is accessible when the caller selects the communication equipment (e.g., mobile communication terminal) along with the integrated communication ID (e.g., pinetree) of the callee and attempts an access.

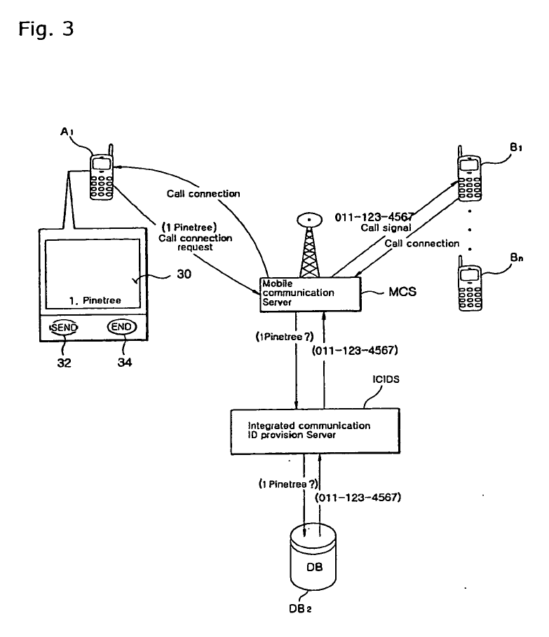

FIG. 3 is a data chart showing a data flow of the system for providing an integrated communication ID according to the first embodiment of the present invention.

Referring to this, in the system for providing an integrated communication ID according to the first embodiment of the present invention, the integrated communication ID provision server ICIDS is connected to a repeating device (e.g., various kinds of interchange servers, repeaters, route servers and the like), which the communication equipment initially connects to, according to a data generating communication equipment (e.g., a mobile communication terminal, wire telephone terminal, PC, . . . etc.). FIG. 3 shows one example of a data flow in which the integrated communication ID provision server ICIDS designates a communication connection route while existing between mobile communication terminals A1˜An and other mobile communication terminals B1˜Bn.

Firstly, the user of any one of mobile communication terminals B1˜Bn connects to the integrated communication ID provision server ICIDS, registers an integrated communication ID ‘pinetree’ in advance, and opens the second database DB2 of the integrated communication ID provision server ICIDS to the mobile communication server MCS. In this state, another user enters ‘1pinetree’ in an input window 30 using mobile communication terminals A1˜An and then operates a snd button 32.

Then, the corresponding mobile communication terminal number and the characters ‘pinetree’ are transmitted to the mobile communication server MCS from the mobile communication terminals A1˜An of the corresponding user. Since the snd button has been operated, the mobile communication server MCS judges this as a signal requesting a call connection to a third person from the corresponding mobile communication terminals A1˜An, and scans the communication service provider's number to which ‘1pinetree’ belongs.

If ‘1pinetree’ does not exist in a communication service provider DB and thus not scannable, the opened second database DB2 of the integrated communication ID provision server ICIDS is sequentially scanned. The integrated communication ID provision server ICIDS is programmed in such a manner that it judges that the number ‘1’ is a mobile communication terminal included in the directory information of integrated communication IDs and judges that ‘pinetree’ is an integrated communication ID.

Accordingly, the integrated communication ID provision server ICIDS extracts a mobile communication terminal number (e.g., 011-123-4567) in the table of an integrated communication ID stored by the name of ‘pinetree’ from the corresponding database and provides it to the mobile communication server MCS.

The mobile communication server MCS allows to establish a call connection between the mobile communication terminals A1˜An of the caller and the mobile communication terminals B1˜Bn having the corresponding number ‘011-123-4567’.

Such flow of the data chart only shows one example in which the integrated communication ID provision server ICIDS extracts and provides a number desired by a repeater among multiple communication equipment access numbers or information, which are low-order information of a specific integrated communication ID, while existing between a communication equipment and the repeater. ‘1’ shows not only an information request of a mobile communication equipment, but also can specify respective communication equipments in various forms by predetermination.

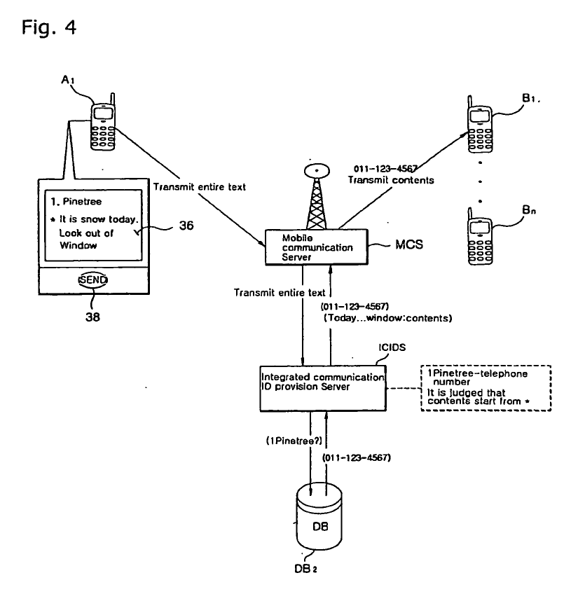

FIG. 4 is a data chart showing another data flow of the system for providing an integrated communication ID according to the first embodiment of the present invention.

Referring to this, in the system for providing an integrated communication ID according to the first embodiment of the present invention, the integrated communication ID provision server ICIDS is connected to a repeating device (e.g., various kinds of interchange servers, repeaters, route servers and the like), which the communication equipment initially connects to, according to a data generating communication equipment (e.g., a mobile communication terminal, wire telephone terminal, PC, . . . etc.), and the user is allowed to enter and transmit an integrated communication ID and a short message at the same time in the same window on mobile communication terminals A1˜An. Thus, FIG. 4 shows one example of a data flow in which the integrated communication ID provision server ICIDS designates a communication connection route and transmits a short message while existing between mobile communication terminals A1˜An and other mobile communication terminals B1˜Bn.

Firstly, the user of any one of mobile communication terminals B1˜Bn connects to the integrated communication ID provision server ICIDS, registers an integrated communication ID ‘pinetree’ in advance, and opens the second database DB2 of the integrated communication ID provision server ICIDS to the mobile communication server MCS. In this state, another user enters an integrated communication ID ‘1pinetree’ and a text ‘*It is snowing today. Look out of the window’ in the same input window 36 using mobile communication terminals A1˜An and then operates a snd button 38.

Then, the mobile communication terminals A1˜An are programmed to transmit the corresponding mobile communication terminal number, the integrated communication ID ‘1pinetree’ and the text ‘*It is snowing today. Look out of the window’ to the mobile communication server MCS. At this time, the special character ‘*’ is an predetermination representing the beginning of a text. The special character ‘*’ representing the beginning of a text has no limitation and may include various special characters, numeric characters and symbols.

And, the mobile communication server MCS judges this as a signal requesting a data transfer to a third person from the corresponding mobile communication terminals A1˜An, and scans the communication service provider's number to which ‘1pinetree’ belongs.

If ‘1pinetree’ does not exist in a communication service provider DB and thus not scannable, the opened second database DB2 of the integrated communication ID provision server ICIDS is sequentially scanned. The integrated communication ID provision server ICIDS is programmed in such a manner that it judges that the number ‘1’ is a mobile communication terminal included in the directory information of integrated communication IDs and judges that ‘pinetree’ is an integrated communication ID.

Accordingly, the integrated communication ID provision server ICIDS extracts a mobile communication terminal number (e.g., 011-123-4567) in the table of an integrated communication ID stored by the name of ‘pinetree’ from the corresponding database and provides it to the mobile communication server MCS. At the same time, ‘*’ representing the beginning of a text is recognized and judged as a request for a short message transfer, and then a data representing that a short message ‘It is snowing today. Look out of the window’ is to be transmitted to a callee number ‘011-123-4567’ is provided to the mobile communication server MCS.

The mobile communication server MCS carries out a data transfer processing so that the corresponding short message can be transmitted to the mobile communication terminals B1˜Bn having the corresponding number ‘011-123-4567’.

Especially, under a recent circumstance that the short messaging service SMS is widely used, both a specific character representing the communication equipment of a callee and a text to be transmitted to the calle can be entered in the same input window in the above-described manner, which is very convenient.

Meanwhile, the integrated communication ID provision server ICIDS carries out an integrated information publicity service IPS such as a kind of 114 service so that an unspecified third person can be provided with an opened information according to a user's intention among various kinds of accessible communication information, e-mail, homepage, vehicle number, . . . and the like that are low-order information of an integrated communication ID allocated to respective users. The existing wire telephone number provision service is restricted only to wire telephone information, however, the present invention allows an unspecified third person to be provided with all or parts of a corresponding information according to a user's intention since a DB is constructed from various communication information and additional information based on integrated communication IDs allocated from the integrated communication ID provision server ICIDS. A detailed description thereof will be described later.

The functions and operation of the thusly configured system for providing an integrated communication ID according to the first embodiment of the present invention will be described in detail with reference to the accompanying drawings.

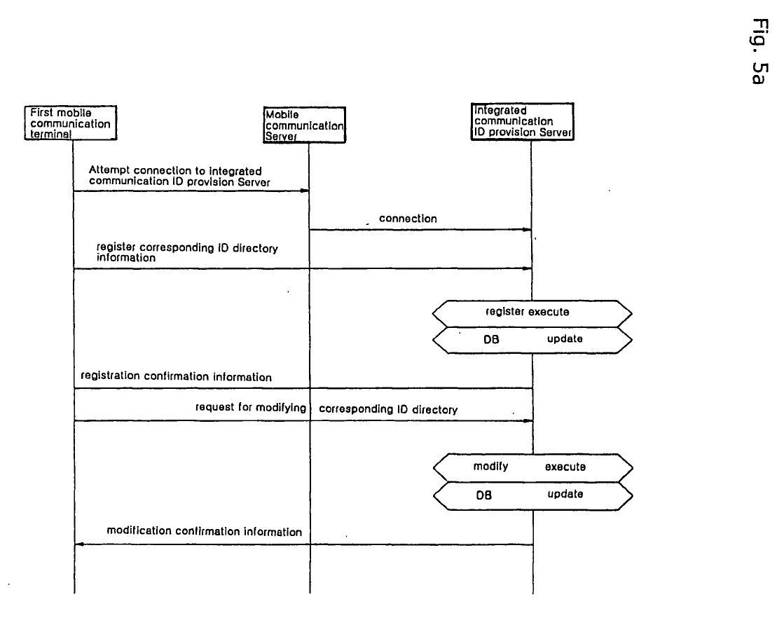

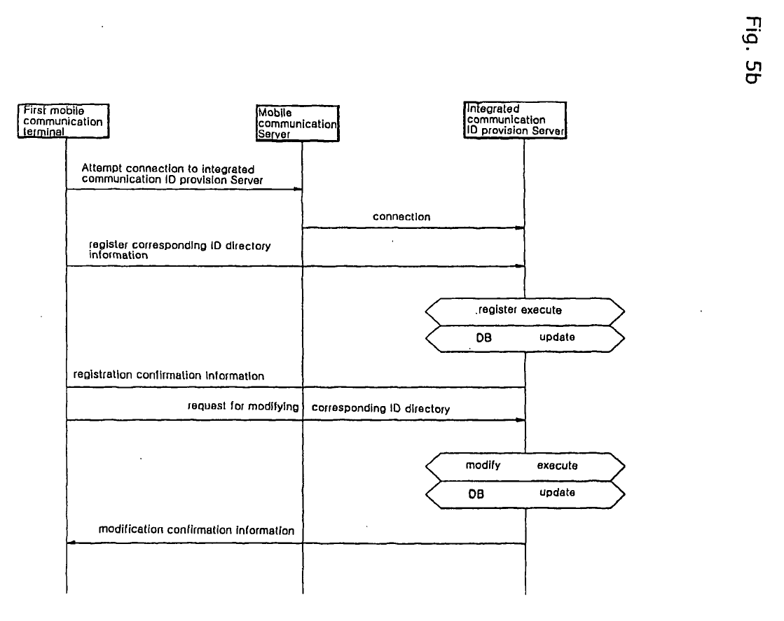

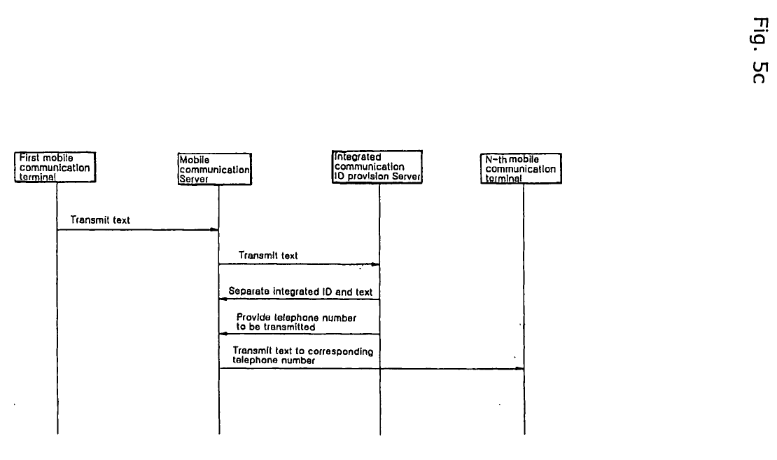

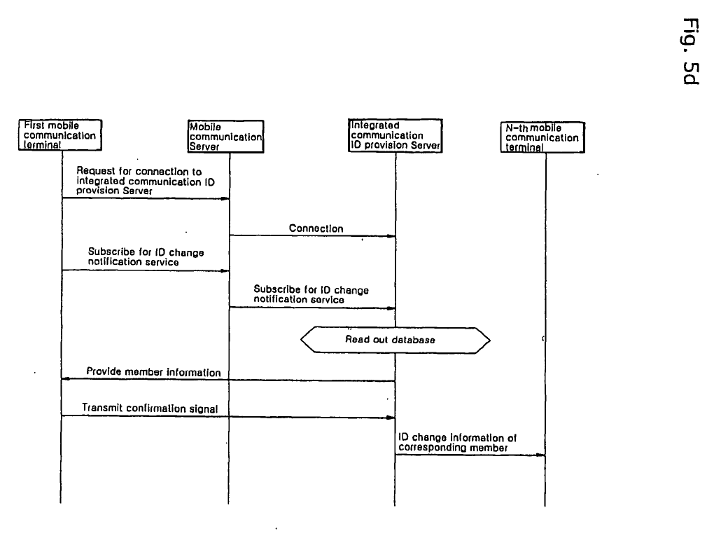

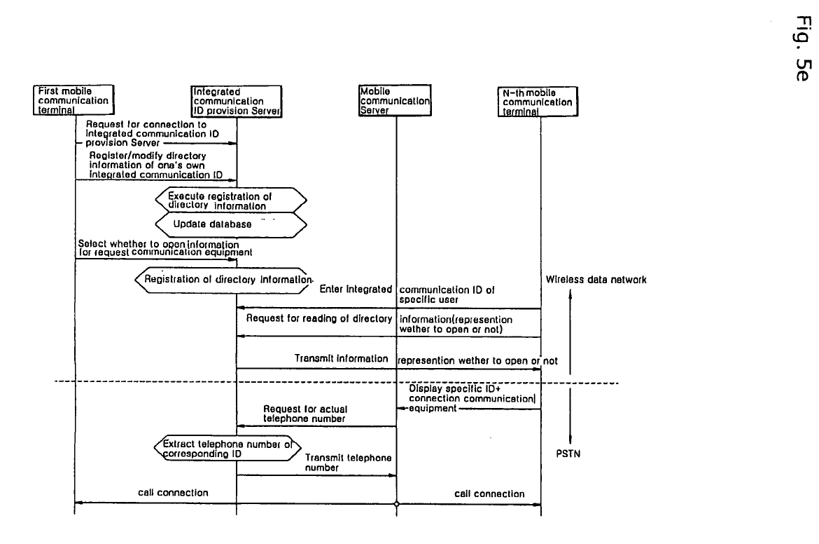

FIGS. 5a to 5e are flow charts showing a signal flow of the system for providing an integrated communication ID according to the first embodiment of the present invention.

FIG. 5a is a flow chart for explaining a procedure of allocating an integrated communication ID which is allocated respectively through the integrated communication ID provision server ICIDS of the system for providing an integrated communication ID according to the first embodiment of the present invention and a procedure of registering and correcting a directory information which is a low-order information linked to the integrated communication ID.

Firstly, the integrated communication ID provision server ICIDS receives the registration of an integrated communication ID sequentially from a multiplicity of users. At this time, an integrated communication ID is allocated respectively like a kind of domain so that the corresponding integrated communication ID can specify a mobile communication terminal, a wire telephone, other communication equipments, a homepage, a vehicle number, e-mail and the like.

Accordingly, a user connects to the integrated communication ID provision server ICIDS through a PC or mobile communication terminals A1˜An and B1˜Bn, then retrieves whether an integrated communication ID (e.g., pinetree) desired to be registered is registered or not, and then subscribes for registration.

In a case that the user has registered a specific integrated communication ID, directory information can be registered according whether the user wants to open this directory information to the public. At this time, respective directory information is allocated a specific number according to a communication equipment. By this, the integrated communication ID provision server ICIDS can judge which communication equipment of the callee the caller wants to connect to through the corresponding specific number. For example, if the caller wants to connect to the personal homepage of the callee using mobile communication terminals A1˜An, the caller enters ‘4pinetree’ and attempts a connection. At this time, the pattern of a call data for attempting a connection consists of a character specifying a communication equipment and an integrated communication ID of the callee.

The user can connect to the integrated communication ID provision server ICIDS to modify the directory information registered in advance in real time by itself. That is, in a case that the user had registered a home telephone number, and now wants to modify it, the user can connect to the integrated communication ID provision server (ICIDS) through a PC or mobile communication terminals A1˜An to cancel the opening of the home telephone number to the public.

FIG. 5b is a flow chart showing a procedure of attempting a call connection through an integrated communication ID individually allocated to a callee through the integrated communication ID provision server ICIDS of the system for providing an integrated communication ID according to the first embodiment of the present invention.

Firstly, in a state that multiple users have connected to the integrated communication ID provision server ACIDS and have individual integrated communication IDs registered, one of the users enters characters ‘1pinetree’ and operates a snd button by using mobile communication terminals A1˜An.

Then, the corresponding mobile communication terminal number and the integrated communication ID (e.g., pinetree) are transmitted to the mobile communication server MCS from the mobile communication terminals A1˜An of the corresponding user. Since the snd button has been operated, the mobile communication server MCS judges this as a signal requesting a call connection to a third person from the corresponding mobile communication terminals A1˜An, and scans the communication service provider's number to which ‘1pinetree’ belongs.

If the integrated communication ID ‘1pinetree’ does not exist in a communication service provider DB and thus not scannable, the opened second database DB2 of the integrated communication ID provision server ICIDS is sequentially scanned. The integrated communication ID provision server ICIDS is programmed in such a manner that it judges that the number ‘1’ is a mobile communication terminal included in the directory information of integrated communication IDs and judges that ‘pinetree’ is an integrated communication ID.

Accordingly, the integrated communication ID provision server ICIDS scans the corresponding integrated communication ID ‘pinetree’ from the corresponding database, and extracts a mobile communication terminal number (e.g., 011-123-4567) in the table of an integrated communication ID stored by the name of ‘pinetree’ from the corresponding database and provides it to the mobile communication server MCS.

The mobile communication server MCS allows to establish a call connection between the mobile communication terminals A1˜An of the caller and the mobile communication terminals B1˜Bn having the corresponding number ‘011-123-4567’.

FIG. 5c is a flow chart illustrating a procedure in the system for providing an integrated communication ID according to the first embodiment of the present invention, in which the integrated communication ID provision server ICIDS is connected to a repeating device (e.g., various kinds of interchange servers, repeaters, route servers and the like), which the communication equipment initially connects to, according to a data generating communication equipment (e.g., a mobile communication terminal, wire telephone terminal, PC, . . . etc.), and the user is allowed to enter and transmit an integrated communication ID and a short message at the same time in the same window on mobile communication terminals A1˜An.

Firstly, the user of any one of mobile communication terminals B1˜Bn connects to the integrated communication ID provision server ICIDS, registers an integrated communication ID ‘pinetree’ in advance, and opens the second database DB2 of the integrated communication ID provision server ICIDS to the mobile communication server MCS. In this state, another user enters an integrated communication ID ‘1pinetree’ and a text ‘*It is snowing today. Look out of the window’ in the same input window using mobile communication terminals A1˜An and then operates a snd button to transmit the corresponding characters.

Once the entering of the integrated communication ID and the characters is finished, the mobile communication terminals A1˜An are programmed to transmit the corresponding mobile communication terminal number, the integrated communication ID ‘1pinetree’ and the text ‘*It is snowing today. Look out of the window’ to the mobile communication server MCS. At this time, the special character ‘*’ is a predetermination representing the beginning of a text. The special character ‘*’ representing the beginning of a text has no limitation and may include various special characters, numeric characters and symbols.

And, the mobile communication server MCS judges this as a signal requesting a data transfer to a third person from the corresponding mobile communication terminals A1˜An, and scans the communication service provider's number to which ‘1pinetree’ belongs.

If ‘1pinetree’ does not exist in a communication service provider DB and thus not scannable, the opened second database DB2 of the integrated communication ID provision server ICIDS is sequentially scanned. The integrated communication ID provision server ICIDS is programmed in such a manner that it judges that the number ‘1’ is a mobile communication terminal included in the directory information of integrated communication IDs and judges that ‘pinetree’ is an integrated communication ID.

Accordingly, the integrated communication ID provision server ICIDS extracts a mobile communication terminal number (e.g., 011-123-4567) in the table of an integrated communication ID stored by the name of ‘pinetree’ from the corresponding database and provides it to the mobile communication server MCS. At the same time, ‘*’ representing the beginning of a text is recognized and judged as a request for a short message transfer, and then a data representing that a short message ‘It is snowing today. Look out of the window’ is to be transmitted to a callee number ‘011-123-4567’ is provided to the mobile communication server MCS.

The mobile communication server MCS carries out a data transfer processing so that the corresponding short message can be transmitted to the mobile communication terminals B1˜Bn having the corresponding number ‘011-123-4567’.

In the system for providing an integrated communication ID according to the first embodiment of the present invention, the integrated communication ID registered to the integrated communication ID provision server ICIDS is re-registrable in real time. The re-registration or changing of the integrated communication ID is similar to the changing of a telephone number. Thus, FIG. 5d is a flow chart illustrating a procedure of notifying specific people of a changed state of an integrated communication ID by character message.

Firstly, the user of any one of mobile communication terminals B1˜Bn connects to the integrated communication ID provision server ICIDS, registers an integrated communication ID ‘pinetree’ in advance, and opens the second database DB2 of the integrated communication ID provision server ICIDS to the mobile communication server MCS. In this state, if the user enters a new integrated communication ID in order to change the integrated communication ID into another one, and requests the integrated communication ID provision server ICIDS to know whether the new integrated communication ID is an existing registered one or not, the integrated communication ID provision server ICIDS retrieves whether the corresponding integrated communication ID is an existing registered one.

If the corresponding communication ID is not an existing registered one, the corresponding integrated communication ID is registered to the second database DB2. At this time, a communication ID change notification service subscription signal is received from mobile communication terminals A1˜An, the user is notified of an information on a multiplicity of registered members. When a confirmation signal thereof is transmitted, the integrated communication provision server ICIDS notifies individual registered members of the integrated communication ID change information of the corresponding user.

Additionally, the integrated communication ID provision server ICIDS carries out an integrated information publicity service IPS such as a kind of 114 service so that multiple users can connect through a mobile communication terminal, a wire telephone, a PC or the like and an unspecified third person can be provided with an opened information including various kinds of accessible communication information, e-mail, homepage, vehicle number, . . . and the like that are low-order information of an integrated communication ID allocated to respective users, according to a user's intention.

According to the embodiment of the present invention, since the integrated communication ID provision server ICIDS has the database of various communication information and additional information constructed based on integrated communication IDs allocated, an unspecified third person can be provided with all or parts of the corresponding information according to the user's intention.

FIG. 5e is a flow chart for explaining a procedure of selecting between the register/open/closed of the directory information of various communication equipments accessible by an individually allocated integrated communication ID through the integrated communication ID provision server ICIDS of the system for providing an integrated communication ID according to the first embodiment of the present invention and a procedure of retrieving a directory information of a specific user.

Firstly, multiple unspecified users connects to the integrated communication ID provision server ICIDS and subscribes for the registration of an integrated communication ID. At this time, an integrated communication ID is allocated respectively like a kind of domain so that the corresponding integrated communication ID can specifically registered with a mobile communication terminal, a wire telephone, other communication equipments, a homepage, a vehicle number, e-mail and the like.

The integrated communication ID provision server ICIDS is connected to an intelligent network server of a wire/wireless communication server to extract an actual communication equipment number information of an integrated communication ID requested by the wire/wireless communication server, thereby freely and conveniently connecting to various communication equipments of a specific user using a single, integrated communication ID.

At this time, upon connecting to the integrated communication ID provision server ICIDS, the user connects to the integrated communication ID provision server ICIDS through web connection via the internet network or through a wireless web network connection via mobile communication terminals A1˜An, and carries out the subscription for registration of an integrated communication ID, the retrieval of whether the integrated communication ID already exists, the registration and modification of multiple communication equipment numbers linked to the corresponding integrated communication ID and the like.

Then, the integrated communication ID provision server ICIDS registers the communication equipment directory information for the corresponding integrated communication ID in the database, and processes update or modify information through data update.

Furthermore, the user can select and register on the web page of the integrated communication ID provision server ICIDS so as to freely open or close the multiple communication equipment information linked with its own integrated communication ID and registered in the database of the integrated communication ID provision server ICIDS, or can open only an access state information such as accessible/inaccessible while not opening actual communication equipment numbers.

The integrated communication ID provision server ICIDS registers directory information according to a user's selection as described above, and then carries out registration on whether the directory information is to be open to the public or not.

Meanwhile, in order that another user can check open information of the directory information for the integrated communication ID registered to the integrated communication ID provision server ICIDS by a specific user, the integrated communication ID provision server ICIDS provides the open information. That is, an unspecified third person connects to the integrated communication ID provision server ICIDS, enters a specific integrated communication ID desired to be retrieved and requests for the retrieval of whether the directory information of the corresponding ID is open to the public or not.

Then, the integrated communication ID provision server ICIDS transmits an information on whether the director information linked to the integrated communication ID of the retrieval target person or an opened directory information to mobile communication terminals A1˜An or PC of the corresponding retrieval requesting person.

If the retrieval requesting person wishes to connects to a specific communication equipment listed in the directory information of the integrated communication ID of the corresponding retrieval target person, the retrieval requesting person transmits connection-desired integrated communication ID and communication equipment indicating information (e.g., information specifying a portable phone, an office phone, a home telephone, . . . and the like) to the integrated communication ID provision server ICIDS.

Then, the integrated communication ID provision server ICIDS establishes a call connection between mobile communication terminals A1˜An of the corresponding retrieval requesting person and a desired communication equipment of a specific integrated communication ID of the retrieval target person. That is, the integrated communication ID provision server ICIDS accomplishes a call connection by transmitting an actual telephone number of the corresponding integrated communication ID to an intelligent network of a mobile communication server or wire interchange server.

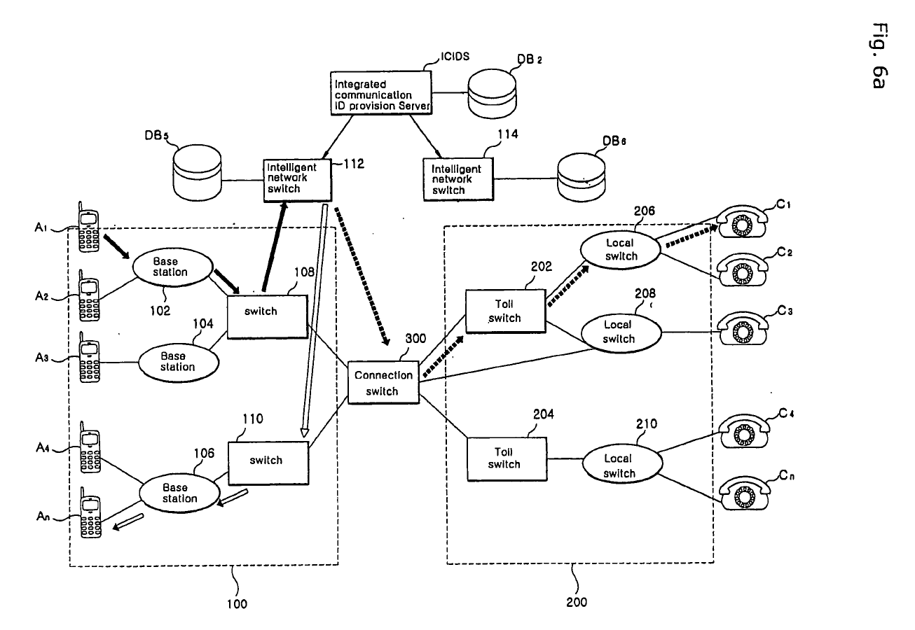

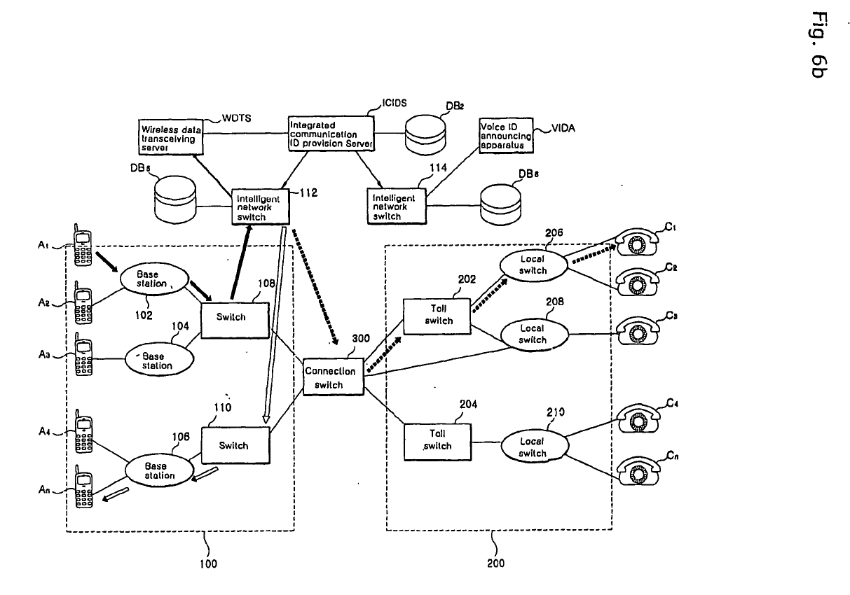

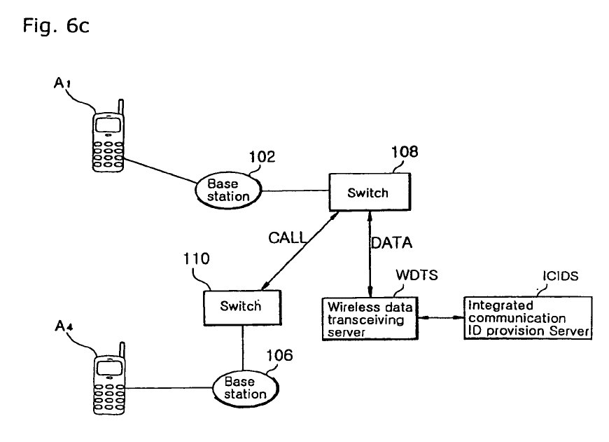

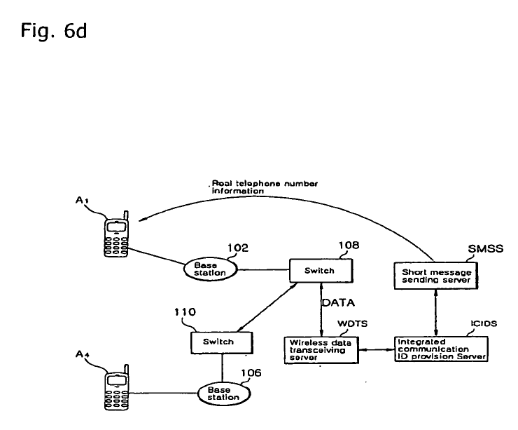

FIGS. 6a to 6d are network configuration views fully illustrating a network configuration of the system for providing an integrated communication ID according to the first embodiment of the present invention.

Referring to this, the system for providing an integrated communication ID according to the first embodiment of the present invention enables a network configuration between mobile communication terminals, between a mobile communication terminal and a wire telephone terminal, between a mobile communication terminal and a remote service server having an individual URL, and between a mobile communication terminal and a facsimile terminal, and the like. That is, the present invention is configured between various terminals or between a terminal and a server, thus it is made possible to easily connect to a target communication equipment such as a terminal or to a communication equipment such as a sever, facsimile, etc. by using an individual, single integrated communication ID.

Preferably, such network is configured on an intelligent network. The intelligent network refers to one of telephone network architectures, that is, a network having the concept of providing the creation and management of a service logic by a particular system so as to add a new service or change an existing service without newly configuring particular switching equipment. In this case, the service quality that users feel can be maintained at the best while minimizing a change of the configuration of the network itself.

Therefore, the telephone network using such intelligent network allows to construct a system enabling the definition of a signal generated from a terminal in the present invention and the translation and switching of the signal.

The network configuration of the present invention is as illustrated in FIG. 6a. That is, it can be adapted to the mobile communication network of FIG. 1 and also adapted to a wire communication network in the same or similar manner as the mobile communication network. FIG. 6a illustrates one example of the network configuration of the present invention adapted to a mobile communication network 100 and a wire communication network 200.

In order to recognize a call connection request signal generated from mobile communication terminals A1˜An, the mobile communication network 100 is provided with base stations 102, 104, 106, . . . for constructing a wireless network with a predetermined radius by regions, and switches 108, 110, . . . for translating a signal based on the call connection request signal received through the base stations 102, 104, 106, . . . . In the switches 108, 110, . . . , a dial tone receiver is configured for translating a signal generated form mobile communication terminals A1˜An.

In recent times, intelligent network switches 112, 114, . . . are further provided for providing various kinds of additional telephone services such as 080, 1588, 700 and the like in Korea, and databases DB5 and DB6 storing connection data on each of the additional services are configured in the intelligent network switches 112, 114, . . . . The dial tone receiver is a number-based receiver, and thus a call connection signal also has to be a number-based one, so it is very difficult to construct a switching system based on characters which are similar to a domain.

However, in a case that a base for connecting to a specific communication equipment is a number-based one, an ID or number allocated to make a call connection to mobile communication terminals A1˜An, wire terminals C1˜Cn and various kinds of servers has to be a number-based one, thus it is impossible to show the characteristics of a company or the individuality of a person. Hence, it is also made impossible to show a recognition or indication function such as a domain by a connection number.

On the other hand, the present invention has such a network configuration in which an individual integrated communication ID is provided to a single user, a single company or a single organization so as to selectively connect to a variety of call connection target communication equipments on a character and number basis, and a call connection can be attempted by using the integrated communication ID.

Additionally, in case of wire terminals C1˜Cn, local switches 206, 208, 210, . . . integrating wire terminals C1˜Cn by regions are configured, and toll switches 202, 204, . . . integrating the local switches 206, 208, 210, . . . by provinces or by administrative districts so as to connect thereto are provided. Meanwhile, connection switches 300, . . . are provided for connecting the wireless communication network 100 and the wire communication network 200.

In the present invention, the integrated communication ID provision server ICIDS is connected to the intelligent network switches 112, 114, . . . , and connection data for respective integrated communication IDs are constructed into a database DB2 so as to connect to a variety of communication equipments (server, facsimile, wire/wireless terminals, . . . etc.), which are a call connection target, by using the connection data for an integrated communication ID and the corresponding integrated communication ID. The connection data of the integrated communication ID provision server ICIDS is a telephone number that a connection code transformed in and received from mobile communication terminals A1˜An and wire terminals C1˜Cn specifies. The integrated communication ID provision server ICIDS extracts a call connection-desired telephone number data and transmits it to the intelligent network switches 112, 114, . . . .

Furthermore, within mobile communication terminals A1˜An and wire terminals (wire terminals capable of inputting characters) C1˜Cn in the present invention, a code conversion algorithm (CEXA) is provided for converting a signal data for connection, i.e., an integrated communication ID of characters or numbers, into a preset code. The code is composed of numeric characters. That is, the code conversion algorithm CEXA is the one for converting into a translatable numeric code since conventional switches 108, 110, . . . are number-based. In a case that the switches 108, 110, . . . are changed into ones capable of character recognition later, this code conversion algorithm CEXA would not be required. Since the present invention is for accessing to a specific communication equipment and a remote server using characters or transmitting data through an one way traffic. Thus, even in a case that the switches 108, 110, . . . are on a character recognizable basis, this is included within the range of the present invention as far as not deviate from the spirit an scope of the invention.

Accordingly, as shown in FIG. 6a, if a user enters an integrated communication ID ‘pinetree00’ through mobile communication terminals A1˜An, the mobile communication terminals A1˜An convert the corresponding integrated communication ID (e.g., pinetree00) into a specific connection code (e.g., 14568900) of numbers by the code conversion algorithm CEXA stored in advance. Here, ‘00’ of ‘pinetree00’ is predetermined to indicate a communication equipment code representing the mobile communication terminals A1˜An, and the number of digits of the code may be different according to what the code is composed of and the total number of users who are allocated an integrated communication ID. Thus, it can be recognized that the user who has entered only ‘pinetree00’ is attempting a connection with the mobile communication terminals A1˜An.

The converted connection code (e.g., 14568900) is transmitted to the switch (e.g., 108) via the base station (e.g., 102), the switch 108 transmits the corresponding connection code (e.g., 14568900) to the intelligent network switch (e.g., 112). Then, the intelligent network switch 112 carries out the retrieval of a database (e.g., DB5) for that connection code 14568900, and if there is no database DB5 for the corresponding connection code 14568900 retrieved, a query for the corresponding connection code 14568900 is performed to the integrated communication ID provision server ICIDS (in the advancing direction of black arrows).

Then, the integrated communication D provision server ICIDS carries out the retrieval of a database DB2 for the corresponding connection code 14568900. In a case that an actual telephone number for the corresponding connection code 14568900 is 011-123-4567, the integrated communication ID provision server ICIDS transmits the actual telephone number to the intelligent network switch 112 along with the connection code 14568900, and the intelligent network switch 112 attempts a call connection through the switch (e.g., 110) processing the corresponding number and the base station (e.g., 106). Further, the connection code (e.g., 54678900) of the caller is transmitted in data packets upon call connection, or separately transmitted after call connection through the base station 102, the switch 108 and the intelligent network switch 112 (in the advancing direction of transparent arrows).

Accordingly, a call connection is established between specific mobile communication terminals (e.g., A1) (e.g., An), and the callee side mobile communication terminal An converts the connection code 54678900 transmitted upon call connection into characters (callee's integrated communication ID: e.g., honggildong00) by the code conversion algorithm CEXA to soft copy them.

At this time, the integrated communication ID provision server ICIDS allows the connection code (e.g., 54678900) to additionally include registered characters to transmit them to the callee side mobile communication terminal An. For instance, when it is assumed that the registered characters are ‘Honggildong Co. Ltd., the creative firm of the 21th century’, the transmitted characters ‘Honggildong Co. Ltd., the creative firm of the 21th century’ as well as the integrated communication ID ‘honggildong00’ is soft copied on the callee side mobile communication terminal An.

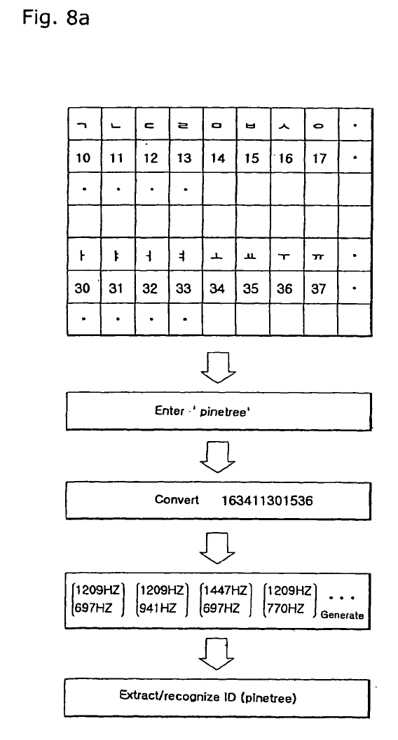

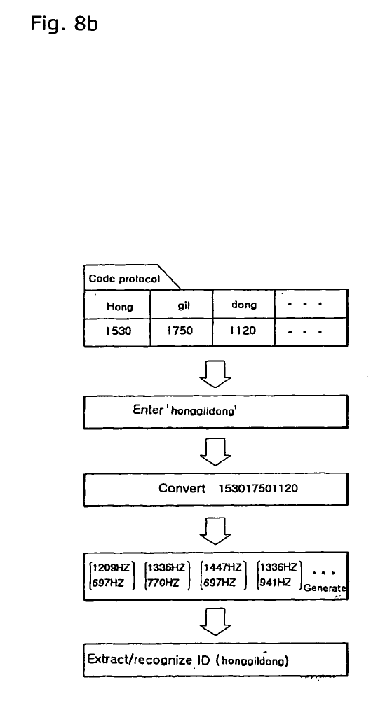

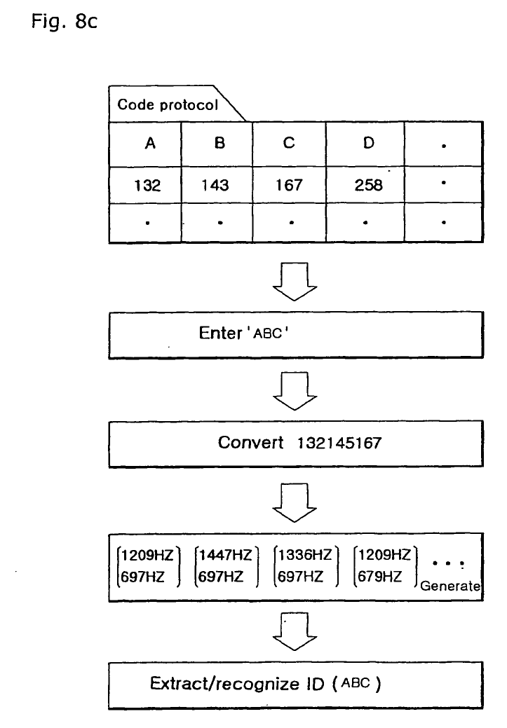

Naturally, the characters registered in the integrated communication ID provision server ICIDS are also registered as the connection code (e.g., 2134556677853432455). Further, the logo of a firm and the like in addition to additional words is transmittable separately after call connection according to whether the user had registered or not. The system for the code conversion algorithm CEXA will be described later with reference to FIGS. 8a, 8b and 8c.

Meanwhile, in case of attempting a call connection to wire terminals C1˜Cn via mobile communication terminals A1˜An in the system for providing an integrated communication ID of the present invention, if a user enters an integrated communication ID ‘pinetree11’ through the mobile communication terminals A1˜An, the mobile communication terminals A1˜An convert the corresponding integrated communication ID (e.g., pinetree11) into a specific connection code (e.g., 14568911) of numbers by the code conversion algorithm CEXA stored in advance. Here, ‘11’ of ‘ pinetree11’ is predetermined to be a communication equipment code representing the wire terminals C1˜Cn. Thus, it can be recognized that the user who has entered only ‘pinetree11’ is attempting a connection with the wire terminals C1˜Cn.

The converted connection code (e.g., 14568911) is transmitted to the switch (e.g., 108) via the base station (e.g., 102), the switch 108 transmits the corresponding connection code (e.g., 14568911) to the intelligent network switch (e.g., 112). Then, the intelligent network switch 112 carries out the retrieval of a database (e.g., DB5) for that connection code 14568911, and if there is no database DB5 for the corresponding connection code 14568911 retrieved, a query for the corresponding connection code 14568911 is performed to the integrated communication ID provision server ICIDS (in the advancing direction of black arrows).

Then, the integrated communication ID provision server ICIDS carries out the retrieval of a database DB2 for the corresponding connection code 14568911. In a case that an actual telephone number for the corresponding connection code 14568911 is 02-123-4567, the integrated communication ID provision server ICIDS transmits the actual telephone number to the intelligent network switch 112 along with the connection code 14568911, and the intelligent network switch 112 connects to a wire network via a connection switch 300 for connecting to a wire network and attempts a call connection through the toll switch (e.g., 202) processing the corresponding number (e.g., 02-123-4567) and the local switch (e.g., 206). Further, the connection code (e.g., 54678900) of the caller is transmitted in data packets upon call connection or separately transmitted after call connection through the toll switch 202, the local switch 206 and the intelligent network switch 112 (in the advancing direction of dotted line arrows).

Accordingly, a call connection is established between specific mobile communication terminals (e.g., A1 and e.g., An), and the callee side wire terminal C1 converts the connection code 54678900 transmitted upon call connection into characters (e.g., honggildong00) by the code conversion algorithm CEXA to soft copy them. Of course, among wire terminals, the terminals incapable of character-displaying a caller cannot soft copy a caller integrated communication ID.

In the present invention, it should be noted that the base stations 102, 104, 106, . . . , the switches 108, 110, . . . , and the intelligent network switches 112, 114, . . . described in FIG. 6a can be commonly designated as the mobile communication server MCS, and the connection switches 300, . . . , the toll switches 202, 204, . . . , and the local switches 206, 208, 210, . . . can be commonly designated as a wire interchange server WIS.

Further, the integrated communication ID provision server ICIDS or the database DB2 in the integrated communication ID provision server ICIDS may be configured within the intelligent network switches 112, 114, . . .

FIG. 6b is a view illustrating a call connection network configuration having a wireless data transceiving server WDTS as a main component.

Referring to this, in the system for providing an integrated communication ID according to the first embodiment of the present invention, a connection system of another type is a communication system primarily utilizing the retrieval of an actual telephone number for a specific integrated communication ID by the use of a wireless data transceiving server WDTS and secondarily utilizing a call connection based on the result of the retrieval.

The system for providing an integrated communication ID of the above method requires no particular signal conversion in mobile communication terminals A1˜An, and minimizes the definition of a signal generated form the terminals and the translation and switching of that signal.

Additionally, such system is a system useful upon a call connection from a mobile communication network 100 to respective mobile communication terminals A1˜An or from the mobile communication network 100 to a wire communication network 200.

The system structure illustrated in FIG. 6b is programmed in such a manner that, if a user enters an integrated communication ID ‘pinetree00’ through mobile communication terminals A1˜An, they are automatically connected to a wireless data transceiving server WDTS via a mobile communication switch 108. That is, the mobile communication terminals A1˜An are programmed in such a manner that, when a user selects an integrated communication mode (e.g., multi-communication mode) of the mobile communication terminals A1˜An according to the present invention, they are automatically connected to the wireless data transceiving server WDTS having a specific wireless IP.

The automatic connection to the wireless data transceiving server WDTS is for connecting to a specific communication equipment having a specific integrated communication ID. In case of a general wireless internet connection, other wireless internet connection mode is employed.

Accordingly, when a specific integrated communication D is transmitted using a certain specific mobile communication terminal A1˜An, the wireless data transceiving server WDTS suggested in the first embodiment of the present invention extracts a communication equipment number, which is the directory information of the corresponding integrated communication ID, and establishes a call connection between the mobile communication terminal (e.g., A1) and a call connection-desired mobile communication terminal (e.g., An). At this time, the communication equipment number information for the specific integrated communication ID is received in response to a query to the integrated communication ID provision server ICIDS connected to the wireless data transceiving server WDTS.

The call connection includes a direct call connection method and a indirect call connection method utilizing a short message transfer. Each method will be explained with reference to FIGS. 6c and 6d.

FIG. 6c is a configuration having a network structure of direct call connection, in which, when a specific integrated communication ID is transmitted utilizing a certain specific mobile communication terminal A1˜An, the wireless data transceiving server WDTS queries the corresponding integrated communication ID to the integrated communication ID provision server ICIDS connected to the wireless data transceiving server WDTS and gets the telephone number of the callee's communication equipment. For instance, in a case that an unspecified user is automatically connected to the wireless data transceiving server WDTS and requests for a mobile communication terminal number for a specific integrated communication ID (e.g., ‘pinetree’) while maintaining a connected state, the wireless data transceiving server WDTS queries the telephone number for the corresponding integrated communication ID (e.g., ‘pinetree’) to the integrated communication ID provision server ICIDS.

Accordingly, the integrated communication ID provision server ICIDS extracts the telephone number (e.g., 011-123-4567) for the corresponding integrated communication ID (e.g., ‘pinetree’) from the database to provides it to the switch 108, and notifies the wireless data transceiving sever WDTS of this to intercept the corresponding user's wireless internet connection to the mobile communication terminal (e.g., A1).

At the same time, the switch 108 establishes a forced call connection between the corresponding user's mobile communication terminal A1 number information and the retrieved telephone number (e.g., 011-123-4567) of the integrated communication ID.

In this case, the mobile communication terminal A1 of the originating user is disabled to establish a wireless internal connection DATA to the wireless data transceiving server WDTS and is enabled to make call because a speech path is opened.

FIG. 6d is a configuration having a network structure of indirect call connection, in which, when a specific integrated communication ID is transmitted utilizing a certain specific mobile communication terminal A1˜An, the wireless data transceiving server WDTS queries the corresponding integrated communication ID to the integrated communication ID provision server ICIDS connected to the wireless data transceiving server WDTS and gets the telephone number of the callee's communication equipment. For instance, in a case that an unspecified user is automatically connected to the wireless data transceiving server WDTS and requests for a mobile communication terminal number for a specific integrated communication ID (e.g., ‘pinetree’) while maintaining a connected state, the wireless data transceiving server WDTS queries the telephone number for the corresponding integrated communication ID (e.g., ‘pinetree’) to the integrated communication ID provision server ICIDS.

Accordingly, the integrated communication ID provision server ICIDS extracts the telephone number (e.g., 011-123-4567) for the corresponding integrated communication ID (e.g., ‘pinetree’) from the database and transmits the telephone number information to the mobile communication terminal A1 of the corresponding user via a short message sending server SMSS located at either of the switch 108 and the integrated communication ID provision server ICIDS.

At the same time, this is notified to the wireless data transceiving sever WDTS to intercept the corresponding user's wireless internet connection to the mobile communication terminal (e.g., A1). The corresponding user having received the telephone number information operates a snd button for the telephone number transmitted to the mobile communication terminal A1 to attempt a call connection.

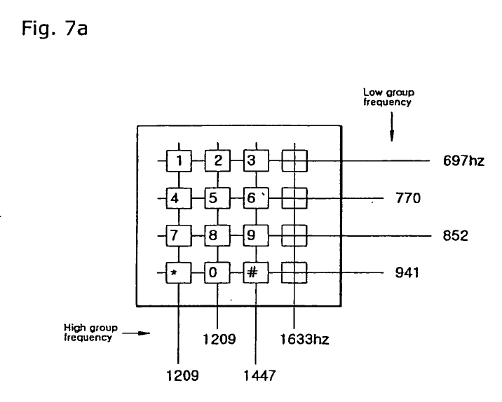

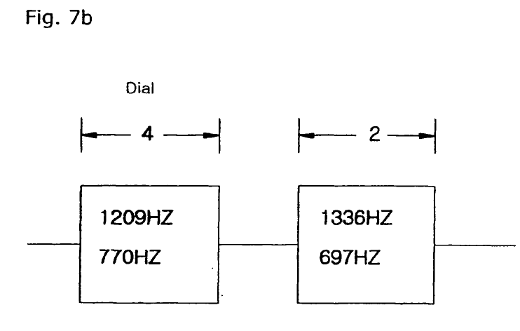

FIGS. 7a and 7b are views illustrating an originating signal of wire/wireless terminals in the system for providing an integrated communication ID according to the first embodiment of the present invention.

Referring to this, an originating signal of push buttons PB representative of the keyboard array of current wire/wireless terminals will be described. In a telephone network configuring current wire/wireless networks, a PB signal employs a 4 4 signaling method. The 4 4 signaling method employs a plurality of frequencies such as low group and high group frequencies and the like. This is for preventing an inaccurate reception at the switches 108, 110, . . . due to noise of a dial signal.

The low group frequency includes 697 Hz, 770 Hz, 852 Hz and 941 Hz while the high group frequency includes 1,209 Hz, 1,336 Hz, 1,477 Hz and 1,633 Hz. * and # are used as functional buttons, and the row of the low group frequencies 697 Hz, 770 Hz, 852 Hz and 941 Hz and the high group frequency 1633 Hz is a preliminary column.

Accordingly, as shown in FIG. 7b, if a user clicks ‘4‘button and ’2′ button respectively, the wire terminals C1˜Cn generates 1209 Hz, 770 Hz, 1336 Hz and 697 Hz. Wireless terminals also generate frequencies in the same manner as above.

FIGS. 8a, 8b and 8c are views illustrating a signal translation procedure in the system for providing an integrated communication ID according to the first embodiment of the present invention.

FIGS. 8a, 8b and 8c illustrate a code conversion through a code conversion algorithm CEXA installed at an originating communication equipment such as mobile communication terminals A1˜An, wire terminals C1˜Cn, computer terminals PC1˜PCn, etc. in the system for providing an integrated communication ID according to the first embodiment of the present invention, and a transmitted data therefor. The code conversion algorithm defines a code system by a plurality of methods on the basis of various languages (in the present invention, Korean and English are exemplified) and numeric characters. The code system exemplified in the present invention is just for illustration only, and other code systems included in the scope and spirit of the invention are also included in the claims of the invention.

The character-code conversion system illustrated in FIG. 8a is configured in such a manner that specific codes, i.e., numbers, are allocated to respective consonants and vowels and a character composed of consonants and vowels is converted into a set of codes and delivered.

For example, if it is assumed that the code conversion algorithm CEXA defines an internal consonant group of [symbol] as ‘10, 11, 13, 14, . . . ’ and an internal vowel group of [symbol] as ‘30, 31, 32, 33, . . . ’, characters for [symbol] (pinetree)’ entered by a user are converted into a connection code of ‘173411301536’.

The converted connection code generates a frequency consistent with ‘173411301536’ corresponding to the connection code as illustrated in FIGS. 7a and 7b. That is, 1 generates a frequency of [1209 Hz, 697 Hz], 7 generates a frequency of [1209 Hz, 94 Hz], 3 generates a frequency of [1447 Hz, 697 Hz], 4 generates a frequency of [1209 Hz, 770 Hz], . . .

The thusly converted frequency is converted back into the connection code (173411301536) by way of the switches 108, 110, . . . and the intelligent network switches 112, 114, . . . , and then transmitted to the integrated communication ID provision server ICIDS. The integrated communication ID provision server ICIDS extracts the actual telephone number of that connection code (173411301536) from the database DB2 and transmit it to the intelligent network switches 112, 114, . . . and the switches 108, 110, . . . , thereby accomplishing a call connection.

Accordingly, the integrated communication ID provision server ICIDS undergoes a procedure of registering a received integrated communication ID and registering a connection code for the integrated communication ID and an actual telephone number for the connection code in advance.

Meanwhile, the character-code conversion system illustrated in FIG. 8b is a method in which specific codes, i.e., numeric codes, are allocated to respective combination characters and then converted into a connection code corresponding to a respective character set and then delivered.

The code conversion algorithm CEXA allocates codes to respective combination characters, for example, if it is assumed that a character [symbol] (hong)’ is defined as code ‘1530’, a character [symbol] (gil)’ is defined as code ‘1750’, and a character [symbol] (dong)’ is defined as code ‘1120’, the characters for the integrated communication ID [symbol] (honggildong)’ entered by the user are automatically converted into a connection code ‘153017501120’.

The converted connection code generates a frequency consistent with ‘153017501120’ corresponding to the connection code as illustrated in FIGS. 7a and 7b. That is, 1 generates a frequency of [1209 Hz, 697 Hz], 5 generates a frequency of [1336 Hz, 770 Hz], 3 generates a frequency of [1447 Hz, 697 Hz], 0 generates a frequency of [1336 Hz, 941 Hz].

The thusly converted frequency is converted back into the connection code (153017501120) by way of the switches 108, 110, . . . and the intelligent network switches 112, 114, . . . , and then transmitted to the integrated communication ID provision server ICIDS. The integrated communication ID provision server ICIDS extracts the actual telephone number of that connection code (153017501120) from the database DB2 and transmit it to the intelligent network switches 112, 114, . . . and the switches 108, 110, . . . , thereby accomplishing a call connection.

Accordingly, the integrated communication ID provision server ICIDS requires a procedure of registering a received integrated communication ID and registering a connection code for the integrated communication ID and an actual telephone number for the connection code in advance.

Meanwhile, the character-code conversion system illustrated in FIG. 8c shows one example of the character-code conversion system that can be achieved on an alphabetical basis, in which specific codes, i.e., numeric codes, are allocated to respective alphabet characters and then converted into a connection code corresponding to a respective character set and then delivered.

The code conversion algorithm CEXA allocates codes to respective alphabetic characters, for example, if it is assumed that a character ‘A’ is defined as code ‘132’, a character ‘B’ is defined as code ‘143’, a character ‘C’ is defined as code ‘167‘and a character ’ D’ is defined as code ‘258’, the characters for the integrated communication ID ‘ABC’ entered by the user are automatically converted into a connection code ‘132143167’.

The converted connection code generates a frequency consistent with ‘132143167’ corresponding to the connection code as illustrated in FIGS. 7a and 7b. That is, 1 generates a frequency of [1209 Hz, 697 Hz], 3 generates a frequency of [1447 Hz, 697 Hz], 2 generates a frequency of [1336 Hz, 697 Hz], 1 generates a frequency of [1209 Hz, 697 Hz], and 4 generates a frequency of [1209 Hz, 679 Hz].

The thusly converted frequency is converted back into the connection code (132143167) by way of the switches 108, 110, . . . and the intelligent network switches 112, 114, . . . , and then transmitted to the integrated communication ID provision server ICIDS. The integrated communication ID provision server ICIDS extracts the actual telephone number of that connection code (132143167) from the database DB2 and transmit it to the intelligent network switches 112, 114, . . . and the switches 108, 110, . . . , thereby accomplishing a call connection.

Accordingly, the integrated communication ID provision server ICIDS requires a procedure of registering a received integrated communication ID and registering a connection code for the integrated communication ID and an actual telephone number for the connection code in advance.

Though not shown, a URL-code conversion system utilizing a wireless web network can be achieved in the same manner as above. For instance, if it assumed that a URL is ‘ABC@msn.com’, even in a case that a user enters ‘ABC@msn.com’ in mobile communication terminals A1˜An using the alphabet-code conversion system as shown in FIG. 8c, it is automatically converted into a connection code (132143167 . . . ) in its transmission to thus be made connectable to the server.

Of course, special characters such as ‘@’ and characters such as ‘.com’ can be built more simply than a code system is built by being allocated special numbers. For instance, it is possible to allocate ‘00’ to ‘@’ while not allocating ‘00’ to an alphabet character. Also, ‘msn, . . . ’, the name of an ISP company, is built using the alphabet-code conversion system of the present invention.

Additionally, in case of most significant domains such as com, net, . . . etc., total 200 most significant domains are present, thus they are identifiable by allocating codes. That is, as for the conversion of a URL into a connection code and the extraction of an actual IP address using the converted connection code, it is preferred to construct a URL-connection code conversion system in such a manner that a three-digit number at the rearmost end is recognized as a most significant domain and separated, numbers located between ‘00’ representing ‘@’ and the most significant domain are recognized as the code of an ISP company, and numbers at the front end before ‘00’ are recognized as a domain.

The present invention is a system in which a single, individual integrated communication ID is allocated and a URL, wire/wireless telephone numbers, a facsimile number, an e-mail address and other information are made into a database in the integrated communication ID provision server ICIDS to thereby make a connection very easy. Accordingly, in the present invention, in a case that the above-stated integrated communication ID is [symbol] (honggildong)’ and the URL of the user is ‘ABC@msn.com’, the connection code (e.g., 153017501120) for [symbol] (honggildong)’ as well as the connection code (e.g., 13214316700145263197) of the URL is stored in the database.

Further, the mobile communication terminals A1˜An can be configured with a specific number representing the URL added to the integrated communication ID. For instance, if it is assumed that a specific number representing the URL is ‘999’ and the code conversion algorithm CEXA is installed in the mobile communication terminals A1˜An, the user enters a specific integrated communication ID ‘ [symbol] 999(honggildong 999)’ through the mobile communication terminals A1˜An.

Then, the integrated communication ID [symbol] (honggildong)’ is converted into a predetermined connection code (e.g., 153017501120), and a number ‘999’ representing the URL is combined thereto to generate a single connection code (e.g., 153017501120999).

The connection code (e.g., 153017501120999) is transmitted to the integrated communication ID provision server ICIDS, and the actual URL stored in linkage with the corresponding connection code is extracted to make a connection to the IP address of the corresponding URL. Meanwhile, the IP address in behalf of the URL stored for a respective connection code may be stored in the integrated communication ID provision server ICIDS.

By the above-described method, even if the user does not remember a telephone number, facsimile number, URL, . . . etc. desired to be connected, he or she can connect to a corresponding connection target apparatus or server very easily. Particularly, this method can be utilized very practically in connecting to a server using a wireless network.

Meanwhile, such exemplified URL-connection code conversion system is just for illustration only. The above method is sufficiently capable of building a URL-connection code conversion system so as to establish a connection even in the event that a URL is entered directly through mobile communication terminals A1˜An.

Hereinafter, a second embodiment of the present invention will be described in detail with reference to the accompanying drawings.

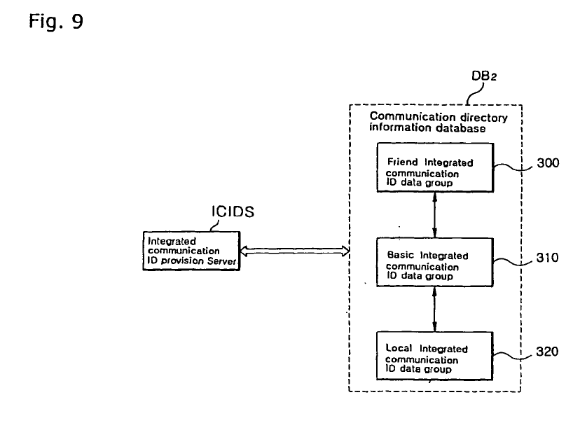

FIG. 9 is a block diagram illustrating various integrated communication IDs provided by the system for providing an integrated communication ID according to a second embodiment of the present invention and a telephone number extraction status in their data groups.

Referring to this, the system for providing an integrated communication ID according to the second embodiment of the present invention allocates a basic integrated communication ID not redundant like a domain, a relational integrated communication ID (=friend integrated communication ID) specifically registrable with a certain user as the central figure and redundant, and a local integrated communication ID in unit of regions given for a commercial use.

As explained in the first embodiment, the basic integrated communication ID is an ID allocated non-redundantly like a domain, that is, an integrated communication ID for allowing an unspecified third person to optionally connect to a specific communication equipment by having various communication equipments registered to the basic integrated communication ID. Though a certain user can own a variety of basic integrated communication IDs, the redundancy of each of the basic integrated communication IDs is impossible like a domain.

The relational integrated communication ID (i.e., friend integrated communication ID) is an integrated communication ID that is allocated to multiple users having some relationship with a certain user with the integrated communication ID of the corresponding user as the central figure and being available only in the relationship with the corresponding user. Although the relational integrated communication ID is non-redundant in the corresponding user group, it can be redundant and available in another user groups even if the relational integrated communication ID exists in the another user groups. For instance, if it is assumed that a relational integrated communication ID ‘wife’ exists in the group of user A, the relational integrated communication ID ‘wife’ is also available in the group of user B. Such relational integrated communication ID can be set and registered with a basic integrated communication ID based upon the basic integrated communication ID.

The relational integrated communication ID (i.e., friend integrated communication ID) is for allowing a user wanting to own a desired integrated communication ID or multiple groups to freely use an integrated communication ID that have no choice but to be redundant for use. That is, in case of widely and commonly used IDs, such as ‘wife’, ‘husband’, ‘father’, etc. and preferred integrated communication IDs, such as ‘princess’, ‘angel’, etc., a corresponding relational integrated communication ID can be used only for a specific user and other relational users registered to the user, with the corresponding user as the central figure.

For this, the mobile communication terminals A1˜An generates a mode selection signal representing whether an integrated communication ID is a basic integrated communication ID, a relational integrated communication ID or a local integrated communication ID, and the integrated communication ID provision server ICIDS recognizes the mode selection signal to execute a processing for a call connection request.

The local integrated communication ID is an integrated communication ID for commercial use, and represents an integrated communication ID, such as ‘Chinese restaurant’, ‘Korean food’, ‘midnight snack’, that is redundant for respective regions and allocated for commercial use so that multiple unspecified users can access thereto. Such local integrated communication ID is allocated to traders or enterprisers involved in the sales of products. If a user attempts to connect to the corresponding local integrated communication ID, the location of the corresponding user is judged to execute a call connection to a local integrated communication ID located at the shortest distance.

Accordingly, the mobile communication terminals A1˜An of the originating user generate a signal representing that the integrated communication ID is a local integrated communication ID, and the integrated communication ID provision server ICIDS recognizes this to thereby execute a processing for a call connection request.

For this, as shown in FIG. 9, a communication directory information database structure of the integrated communication ID provision server ICIDS is configured in such a manner that a friend integrated communication ID data group 300 and a local integrated communication ID data group 320 are linked with a basic integrated communication ID data group 310.

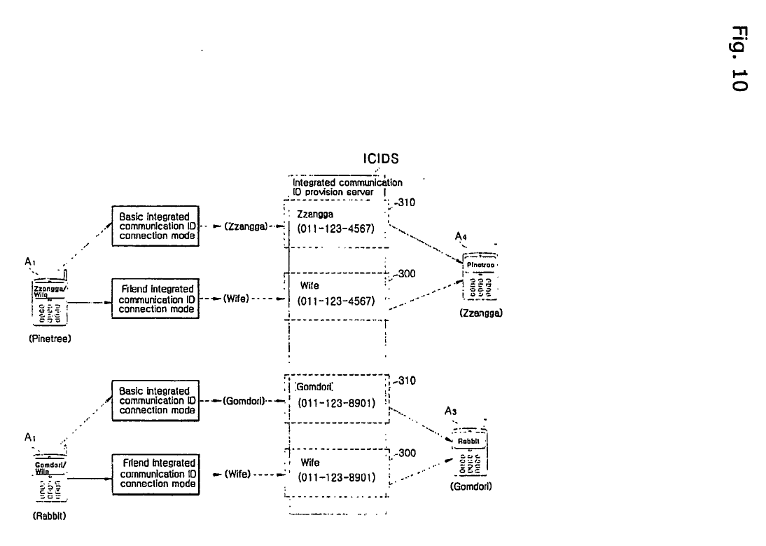

FIG. 10 is a status view illustrating a call connection status utilizing a basic integrated communication ID and a relational integrated communication ID provided by the system for providing an integrated communication ID according to the second embodiment of the present invention.

Referring to this, FIG. 10 is a view exemplifying a status of connecting to a relational integrated communication ID. For example, in the case that the basic integrated communication ID of a certain originating user is ‘pinetree’ and the basic integrated communication ID desired to be connected is ‘zzangga’, the originating user (pinetree) registers the user (zzangga) as a relational integrated communication ID ‘wife’ in the integrated communication ID provision server ICIDS and then the originating user (pinetree) enters the integrated communication ID ‘zzangga’ in the basic integrated communication ID connection mode using the mobile communication terminal A1. Then, the integrated communication ID provision server ICIDS retrieves the connection information, i.e., the integrated communication ID ‘zzangga’, from the basic integrated communication ID data group 310, and extracts the original telephone number (e.g., 011-123-4567) to establish a call connection.

Additionally, if the originating user (pinetree) enters an integrated communication ID ‘wife’ in the relational integrated communication ID connection mode utilizing the mobile communication terminal A1, the integrated communication ID provision server ICIDS retrieves the connection information, i.e., the integrated communication ID ‘wife’, from the friend integrated communication ID data group 300, and extracts the original telephone number (e.g., 011-123-4567) to establish a call connection.

Similarly, when another originating user (rabbit) registers a connection-desired user (gomdori) to the integrated communication ID provision server ICIDS as a relational integrated communication ID ‘wife’, and then enters the integrated communication ID ‘wife’ in the relational integrated communication ID connection mode utilizing the mobile communication terminal A2, the integrated communication ID provision server ICIDS retrieves the connection information, i.e., the integrated communication ID ‘wife’, from the friend integrated communication ID data group 300, and extracts the original telephone number (e.g., 011-123-8901) to establish a call connection.

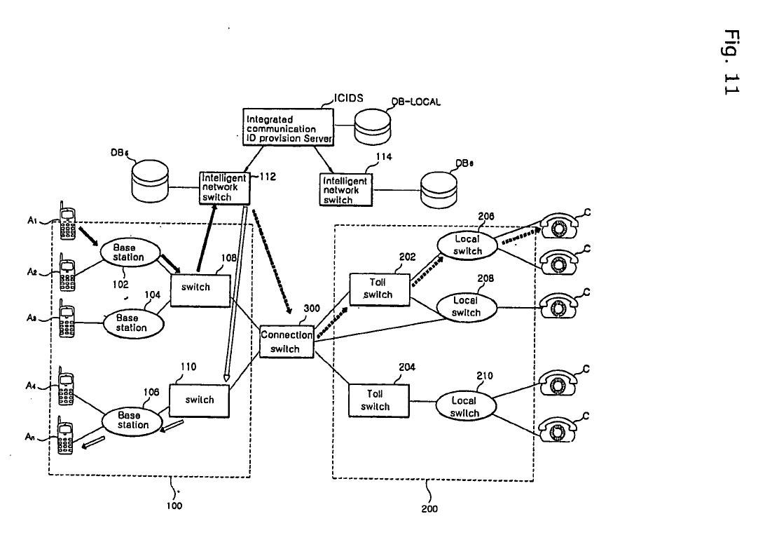

FIG. 11 is a view fully illustrating a call connection network configuration utilizing a local integrated communication ID of the system for providing an integrated communication ID according to the second embodiment of the present invention.

Referring to this, in the system for providing an integrated communication ID according to the second embodiment of the present invention, a network for implementing a local integrated communication ID is configured between mobile communication terminals, between a mobile communication terminal and a wire telephone terminal, between a mobile communication terminal and a remote service server having an individual URL, and between a mobile communication terminal and a facsimile terminal.

FIG. 11 illustrates one example of the network configuration of the present invention that is adapted to a mobile communication network 100 and a wire communication network 200.

In order to recognize a call connection request signal generated from mobile communication terminals A1˜An, the mobile communication network 100 is provided with base stations 102, 104, 106, . . . for constructing a wireless network with a predetermined radius by regions, and switches 108, 110, . . . for translating a signal based on the call connection request signal received through the base stations 102, 104, 106, . . . . In the switches 108, 110, . . . , a dial tone receiver is configured for translating a signal generated form mobile communication terminals A1˜An.

In recent times, intelligent network switches 112, 114, . . . are further provided for providing various kinds of additional telephone services such as 080, 1588, 700 and the like, and databases DB5 and DB6 storing connection data on each of the additional services are configured in the intelligent network switches 112, 114, . . . . The dial tone receiver is a number-based receiver.

Additionally, in case of wire terminals C1˜Cn, local switches 206, 208, 210, . . . integrating wire terminals C1˜Cn by regions are configured, and toll switches 202, 204, . . . each integrating the local switches 206, 208, 210, . . . by provinces or by administrative districts so as to connect thereto are provided. Meanwhile, connection switches 300, . . . are provided for connecting the wireless communication network 100 and the wire communication network 200.

In the present invention, the integrated communication ID provision server ICIDS is connected to the intelligent network switches 112, 114, . . . , and connection data for respective local integrated communication IDs are constructed into a local integrated communication ID database DB-Local, in linkage with the database storing basic integrated communication IDs, so as to connect to a variety of communication equipments (server, facsimile, wire/wireless terminals, . . . etc.), which are a call connection target, by using the connection data for an integrated communication ID and the corresponding integrated communication ID.

Additionally, in the present invention, the switches 108 and 110 or the intelligent network switch 112 recognizes the location of the base stations 102, 104, 106, . . . initially generating a call connection through the mobile communication terminals A1˜An of the originating user, and the integrated communication ID provision server ICIDS establishes a call connection to the user located within the shortest distance among the users owning the corresponding integrated communication ID by utilizing the location information.

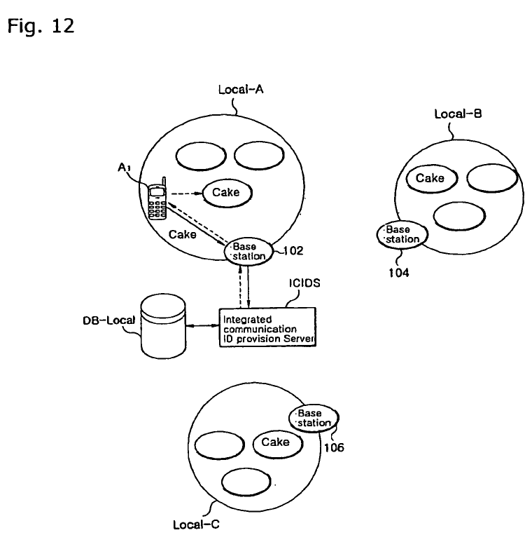

FIG. 12 is a status view illustrating a call connection status utilizing a local integrated communication ID of the system for providing an integrated communication ID according to the second embodiment of the present invention.

Referring to this, in the system for providing an integrated communication ED according to the second embodiment of the present invention, preferably, multiple users are allocated a specific local integrated communication ID in advance by unit of administrative districts (for example, street, county, town) for a commercial purpose. It is assumed that there exists only a single user (enterpriser) in each of different regions (Local-A, Local-B, Local-C) who has the same local integrated communication ID (e.g., cake) allocated.

At this time, if a certain unspecified users enters the local integrated ID (cake) in the local integrated communication ID mode of the mobile communication terminal (e.g., A1) in order to give an order for a product to the user having the local integrated communication ID allocated, the information is provided to the integrated communication ID provision server ICIDS by way of a base station and a switch. At the same time, the integrated communication ID provision server ICIDS gets the base station location information of the corresponding originating region from the switch or gets the location information of the mobile communication terminal A1 utilizing a GPS chip within the mobile communication terminal A1.

With the location of the corresponding user detected, the integrated communication ID provision server ICIDS extracts the telephone number of the person who owns the local integrated communication ID ‘cake’ within a regional range to which the location of the corresponding user belongs from the data base and transmits the telephone number information to the mobile communication terminal A1 of the user to make a call connection.

The local integrated communication ID is an integrated communication ID for commercial use, and is redundant for respective regions, such as ‘Chinese restaurant’, ‘Korean food’, ‘midnight snack’ and the like. However, the same local integrated communication ID is not redundant within the corresponding regional range.

Hereinafter, a third embodiment of the present invention will be described in detail with reference to the accompanying drawings.

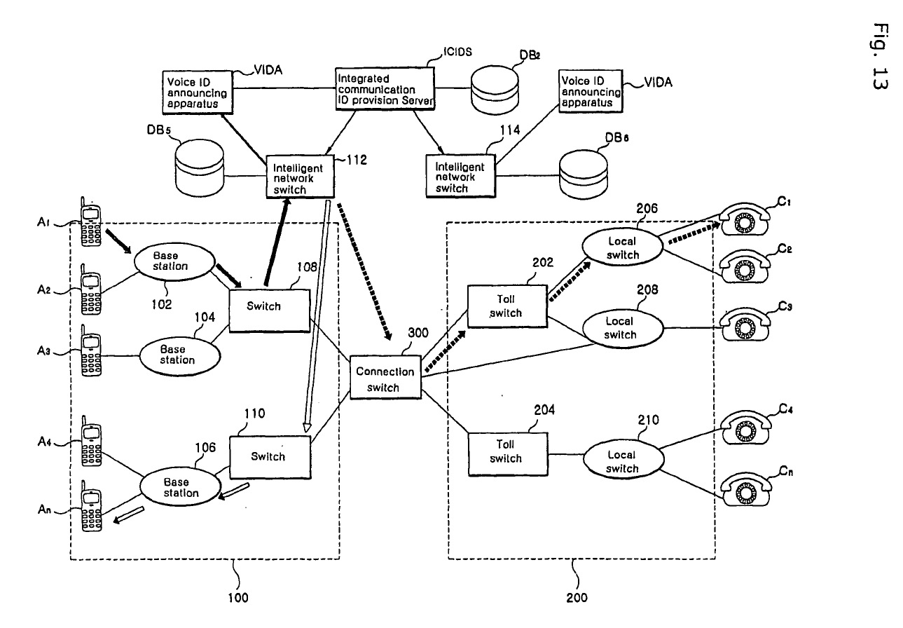

FIG. 13 is a view fully illustrating a call connection network configuration utilizing a local integrated communication ID of the system for providing an integrated communication ID according to a third embodiment of the present invention.

Referring to this, the system for providing an integrated communication ID according to the third embodiment of the present invention enables a network configuration between mobile communication terminals, between a mobile communication terminal and a wire telephone terminal, between a mobile communication terminal and a remote service server having an individual URL, and between a mobile communication terminal and a facsimile terminal. thus it is made possible to easily connect to a target communication equipment such as a terminal or to a communication equipment such as a sever, facsimile, etc. by using an individual, single integrated communication ID.

Such network is configured on an intelligent network. The intelligent network refers to one of telephone network architectures, that is, a network having the concept of providing the creation and management of a service logic by a particular system so as to add a new service or change an existing service without newly configuring particular switching equipment. In this case, the service quality that users feel can be maintained at the best while minimizing a change of the configuration of the network itself.

Therefore, the telephone network using such intelligent network allows to construct a system enabling the definition of a signal generated from a terminal in the present invention and the translation and switching of the signal. The network configuration of the present invention is as illustrated in FIG. 13.

That is, it can be adapted to the mobile communication network of FIG. 1 and also adapted to a wire communication network in the same or similar manner as the mobile communication network. FIG. 13 illustrates one example of the network configuration of the present invention adapted to a mobile communication network 100 and a wire communication network 200, and is one example for fully representing a voice call connection.

In order to recognize a call connection request signal generated from mobile communication terminals A1˜An, the mobile communication network 100 is provided with base stations 102, 104, 106, . . . for constructing a wireless network with a predetermined radius by regions, and switches 108, 110, . . . for translating a signal based on the call connection request signal received through the base stations 102, 104, 106, . . . . In the switches 108, 110, . . . , a dial tone receiver is configured for translating a signal generated form mobile communication terminals A1˜An.

In recent times, intelligent network switches 112, 114, . . . are further provided for providing various kinds of additional telephone services such as 080, 1588, 700 and the like, and databases DB5 and DB6 storing connection data on each of the additional services are configured in the intelligent network switches 112, 114, . . . . The dial tone receiver is a number-based receiver, and thus a call connection signal also has to be a number-based one. Therefore, in the present invention, for making a voice call connection, a voice call connection key button (not shown) added to mobile communication terminals A1˜An or to wire terminals C1˜Cn, or a call connection attempts is made to a specific number before anything else.

Also in the case where the voice call connection key button added to mobile communication terminals A1˜An or to wire terminals C1˜Cn is operated, a call connection attempt is made to a specific number before anything else.

In case of wire terminals C1˜Cn, local switches 206, 208, 210, . . . integrating wire terminals C1˜Cn by regions are configured, and toll switches 202, 204, . . . integrating the local switches 206, 208, 210, . . . by provinces or by administrative districts so as to connect thereto are provided. Meanwhile, connection switches 300, . . . are provided for connecting the wireless communication network 100 and the wire communication network 200.

In the present invention, the integrated communication ID provision server ICIDS is connected to the intelligent network switches 112, 114, . . . , and connection data for respective integrated communication IDs are constructed into a database DB2 so as to connect to a variety of communication equipments (server, facsimile, wire/wireless terminals, . . . etc.), which are a call connection target, by using the connection data for an integrated communication ID and the corresponding integrated communication ID. The connection data of the integrated communication ID provision server ICIDS is a telephone number that a connection code transformed in and received from mobile communication terminals A1˜An and wire terminals C1˜Cn specifies. The integrated communication ID provision server ICIDS extracts a call connection-desired telephone number data and transmits it to the intelligent network switches 112, 114, . . . .

In this embodiment, for a voice call connection attempt of a user, the integrated communication ID provision server ICIDS is provided with a voice ID announcing device VIDA for converting voice data into characters of an integrated communication ID. The voice ID announcing device VIDA converts the integrated communication ID in voice into characters. Thus, the integrated communication ID provision server ICIDS extracts the actual telephone number linked with that character data. And, the integrated communication ID provision server ICIDS is provided with a code conversion algorithm CEXA for converting the integrated communication ID of an originating source into a preset code.

Accordingly, as shown in FIG. 13, the user operates a specific button for voice call connection through mobile communication terminals A1˜An or attempts a call connection to a specific number allocated and connectable to the integrated communication ID provision server ICIDS, and then enters in voice a connection-desired integrated communication ID ‘pinetree’.

Then, the integrated communication ID provision server ICIDS converts the integrated communication ID ‘pintree’ of a call connection target through the voice ID announcing device VIDA, and extract the actual telephone number of the ‘pinetree’. At this time, the voice ID announcing device VIDA may be provided respectively at the intelligent network switches 112, 114, . . . , or may be provided alone at the integrated communication ID provision server ICIDS.

Preferably, the integrated communication ID provision server ICIDS can be configured to query what communication equipment would be used as mobile communication terminals A1˜An of a call connected caller for connecting to the call connection target's ID ‘pinetree’. The integrated communication ID provision server ICIDS is capable of voice outputting to mobile communication terminals A1˜An like an ARS apparatus. That is, voice inputting can be carried out in such a manner that the user can operates number ‘1’ for connection to the mobile communication terminal of ‘pinetree’, number ‘2’ for connection to a wire terminal, number ‘3’ for data transmission to a facsimile, number ‘4’ for homepage connection to a homepage, number ‘5’ for voice message storage, and number ‘6’ for call number storage.

If the originating user keys in number ‘1’, the integrated communication ID provision server ICIDS extracts the actual mobile communication telephone number of the user having the corresponding integrated communication ID and transmits it to the intelligent network switches 112, 114, . . . and the switches 108, 110, . . . to thereby establish a call connection.

At this time, the integrated communication ID provision server ICIDS converts the integrated communication ID of the originating user's mobile communication terminal (e.g., A1) into a connection code and delivers it to thus soft copy the integrated communication ID of the caller on the mobile communication terminal (e.g., An) of the called user. The conversion into a connection code achieved in the integrated communication ID provision server ICIDS and the conversion into an integrated communication ID achieved in the mobile communication terminal (e.g., An) of the called user are described with reference to FIGS. 6a, 6b, 6c and 6d and FIGS. 5a, 8b and 8c., thus a description thereof will be omitted.

Subsequently, the user can get information on various communication equipments from the integrated communication ID provision server ICIDS by voice inputting, and can connect to a communication equipment or homepage of the corresponding call connection target person by a simple key operation.

Hereinafter, a fourth embodiment of the present invention will be described in detail with reference to the accompanying drawings.

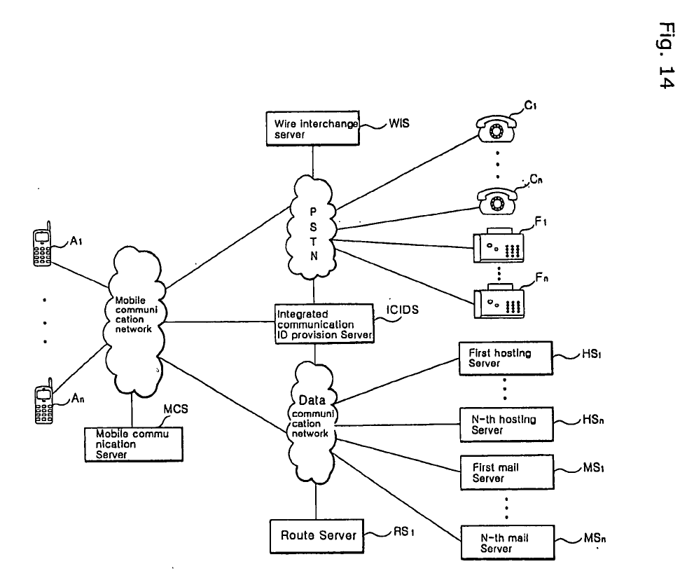

FIG. 14 is a block diagram illustrating a schematic configuration of a system for providing an integrated communication ID according to a fourth embodiment of the present invention.

Referring to this, the system for providing an integrated communication ID according to the fourth embodiment of the present invention allows to connect to various kinds of communication equipments of a specific user utilizing an integrated communication ID. At this time, mobile communication terminal A1˜An are just an illustration of information originating equipment, but the information originating equipment is not limited thereto and includes all kinds of equipment capable of transmitting data.

In the system for providing an integrated communication ID according to the fourth embodiment of the present invention, in the case that the communication targets a user registered as a directory information in the integrated communication ID provision server ICIDS are general telephone terminals C1˜Cn, facsimiles F1˜Fn, homepage information, mail information and the like, this is very convenient because the communication targets are accessible respectively in real time and the user does not have to remember the number or ID for the communication targets.

For this, the integrated communication ID provision server ICIDS is connected to a wire interchange server WIS executing the interchange of wire telephone voice data and facsimile data, and, like the mobile communication server MCS, opens the second database DB2 built in the integrated communication ID provision server ICIDS to the public.

Further, the integrated communication ID provision server ICIDS is connected to various hosting servers HS1˜HSn managing a multiplicity of homepages and a route server RS1 designating the IP and URL route of mail server MS1˜MSn executing a mailing service.

Accordingly, when the user transmits a specific integrated communication ID utilizing any one of communication equipment (e.g., mobile communication terminals A1˜An), it is possible to connect to various kinds of communication equipment having the corresponding integrated communication ID by way of the interchange server.

For example, when the user enters a specific integrated communication ID ‘2pinetree’ and attempts a call connection by utilizing mobile communication terminals A1˜An, the wire interchange server WIS retrieves ‘2pinetree’ by scanning its database. As a result, if there is no ‘2pinetree’ existing in the database of the wire interchange server WIS, the wire interchange server WIS connects to the second database DB2 linked of the integrated communication ID provision server ICIDS to make a query request whether the corresponding integrated communication ID ‘2pinetree’ exists or not.

The integrated communication ID provision server ICIDS scans whether the integrated communication ID ‘pinetree’ exists, and, if so, reads out a low-order directory information of the corresponding integrated communication ID, recognizes that ‘2’ represents a home telephone number, and then extracts the home telephone number (e.g., 02-123-45567) as shown in FIG. 2 to transmit it to the wire interchange server WIS to establish a call connection.

Similarly as in the case of a facsimile, the wire interchange server WIS is used because a call connection is made by the use of a PSTN network. Further, the user can transmit data to facsimiles F1˜Fn located a long distance by entering through mobile communication terminals A1˜An or calling specific characters stored in the mobile communication terminals A1˜An. In this case, also, a facsimile transmission is enabled by using the integrated communication ID related to the destination through the mobile communication terminals A1˜An even in the event that the user does not recognize the facsimile number of the destination.

For example, if the facsimile number of an office where a certain user works is 02-456-7890′ and the integrated communication ID of the corresponding user is ‘pinetree’, the originating user enters a character (e.g., ‘7’) specifying the facsimile number by utilizing the mobile communication terminals A1˜An and then enters the integrated communication ID ‘pinetree’, thereby transmitting a specific data.

The integrated communication ID and the data to be transmitted are issued to the wire interchange server WIS. The integrated communication ID provision server ICIDS transmits the corresponding facsimile number according to a query of the wire interchange server WIS and identifies which data is to be transmitted. Thus, the wire interchange server WIS can transmit a specific data to the corresponding facsimile number.

In case of a homepage, connection is made by the use of a data communication network (internet network, wireless internet network, . . . and the like), thus it is necessary to connect to hosting servers HS1˜HSn managing the homepage through an IP address or URL. At this time, the connection to the homepage having the corresponding address undergoes a routing procedure and a rooting procedure. The routing and rooting procedures are procedures for designating a connection route so that a caller can connect to the corresponding homepage. This is a generally known art, so a detailed description thereof will be omitted.

Accordingly, in the case that it is desired to access to a specific homepage from the outside, a multiplicity of route servers RS1˜RSn are present among a connection line. Such route servers RS1˜RSn are operable in conjunction with a windows program, or operable in a sub program of the windows program.

For instance, the homepage owned by a certain user is ‘www.hongdong.co.kr’ and the integrated communication ID of the corresponding user is ‘pinetree’, the originating user can transmit a specific data by entering a character (e.g., ‘4’) specifying homepage and the integrated communication ID ‘pinetree’ by utilizing the mobile communication terminals A1˜An.

The integrated communication ID is issued to the mobile communication server MCS and the mobile communication server MCS connects to the integrated communication ID provision server ICIDS to execute a query request for the corresponding integrated communication ID, for example, ‘4pinetree’. The integrated communication ID provision server ICIDS receives the query request for the integrated communication ID ‘4pinetree’, recognizes that the query request for the corresponding integrated communication ID is a connection to the URL having ‘www.hongdong.co.kr’ by database scanning, and transmits the URL information to the mobile communication server MCS.

The mobile communication server MCS transmits the ‘www.hongdong.co.kr’ information to the route server RS1 so that the corresponding mobile communication terminal A1˜An can connect to the corresponding homepage.

Similarly as in the case of e-mail, in the case that it is desired to access to a specific mail server MS1˜MSn from the outside, a multiplicity of route servers RS1˜RSn are present among a connection line. Such route servers RS1˜RSn are operable in conjunction with a windows program, or operable in a sub program of the windows program.

For instance, the e-mail address owned by a certain user is ‘hongdong@mails.net’ and the integrated communication ID of the corresponding user is ‘pinetree’, the originating user can transmit a specific data by entering a character (e.g., ‘5’) specifying e-mail and the integrated communication ID ‘pinetree’ by utilizing the mobile communication terminals A1˜An.

The integrated communication ID is issued to the mobile communication server MCS and the mobile communication server MCS connects to the integrated communication ID provision server ICIDS to execute a query request for the corresponding integrated communication ID, for example, ‘5pinetree’. The integrated communication ID provision server ICIDS receives the query request for the integrated communication ID ‘4pinetree’, recognizes that the query request for the corresponding integrated communication ID is a connection to the address having ‘hongdong@mails.net’ by database scanning, and transmits the address information to the mobile communication server MCS.

The mobile communication server MCS is enabled to transmit e-mail to the user having the address ‘hongdong@mails.net’ by way of the route server RS1 and the specific mail server MS1˜MSn.

The above method is a description of one example of using an individual, single integrated communication ID allocated by integrating multiple communication information according to the present invention, and an explanation of an additive low-level concept for executing the one example will be omitted.

Additionally, the integrated communication ID allocated individually to the user includes numeric characters, special characters, images, some images captured from moving images, as well as every kind of characters.

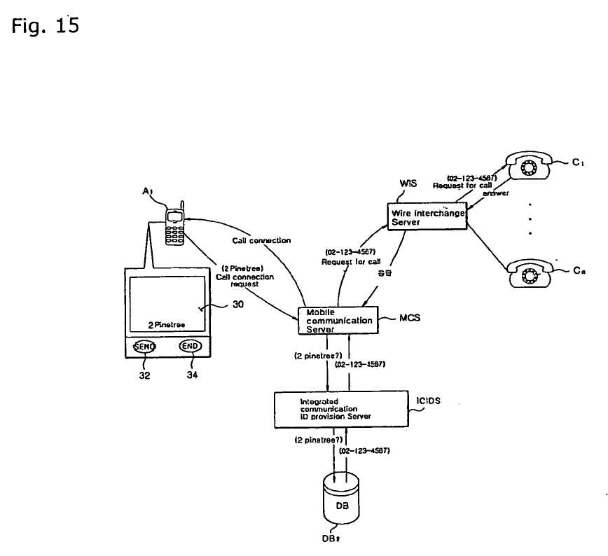

FIG. 15 is a view showing a data flow of the system for providing an integrated communication ID according to the fourth embodiment of the present invention.

Referring to this, the system for providing an integrated communication ID according to the fourth embodiment of the present invention allows to connect to a specific mobile communication terminal A1˜An by originating from a wire telephone terminal C1˜Cn by utilizing a specific integrated communication ID, and also allows to connect to a specific wire telephone terminal C1˜Cn from mobile communication terminals A1˜An. FIG. 15 is an illustration of one example of making a call by connecting to a specific wire telephone terminal C1˜Cn by way of mobile communication terminals A1˜An.

Firstly, when a user transmits a specific integrated communication ID by utilizing mobile communication terminals A1˜An, the user is enabled to connect to various kinds of communication equipment having the corresponding integrated communication ID by way of an interchange server.

For example, when the user enters a specific integrated communication ID ‘2pinetree’ and attempts a call connection by utilizing mobile communication terminals A1˜An, the wire interchange server WIS retrieves ‘2pinetree’ by scanning its database. As a result, if there is no ‘2pinetree’ existing in the database of the wire interchange server WIS, the wire interchange server WIS connects to the second database DB2 linked of the integrated communication ID provision server ICIDS to make a query request whether the corresponding integrated communication ID ‘2pinetree’ exists or not.

The integrated communication ID provision server ICIDS scans whether the integrated communication ID ‘pinetree’ exists, and, if so, reads out a low-order directory information of the corresponding integrated communication ID, recognizes that ‘2’ represents a home telephone number, and then extracts the home telephone number (e.g., 02-123-4567) as shown in FIG. 2 to transmit it to the wire interchange server WIS to establish a call connection.

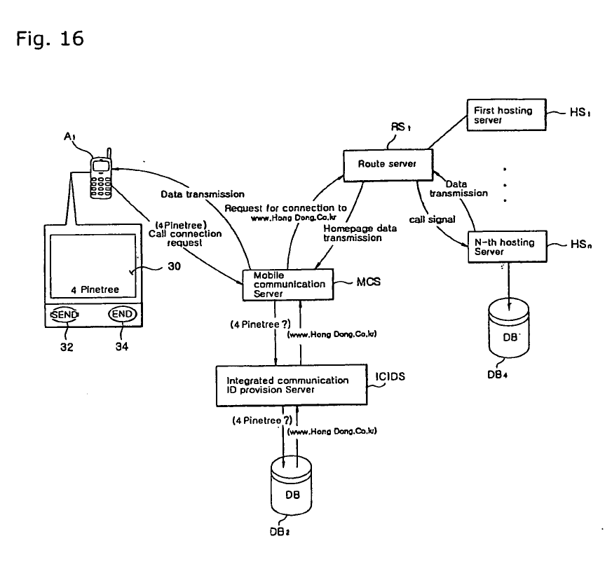

FIG. 16 is a view showing another data flow of the system for providing an integrated communication ID according to the fourth embodiment of the present invention.

Referring to this, even in the event that a user connects to the homepage of a third person at a long distance by way of a wireless web network by utilizing mobile communication terminals A1˜An, the system for providing an integrated communication ID according to the fourth embodiment of the present invention allows a connection without knowing the homepage URL, but only the integrated communication ID perceived.

For instance, the homepage owned by a certain user is ‘www.hongdong.co.kr’ and the integrated communication ID of the corresponding user is ‘pinetree’, the originating user can transmit a specific data by entering a character (e.g., ‘4’) specifying homepage and the integrated communication ID ‘pinetree’ by utilizing the mobile communication terminals A1˜An.

The integrated communication ID is issued to the mobile communication server MCS and the mobile communication server MCS connects to the integrated communication ID provision server ICIDS to execute a query request for the corresponding integrated communication ID, for example, ‘4pinetree’. The integrated communication ID provision server ICIDS receives the query request for the integrated communication ID ‘4pinetree’, recognizes that the query request for the corresponding integrated communication ID is a connection to the URL having ‘www.hongdong.co.kr’ by database scanning, and transmits the URL information to the mobile communication server MCS.

The mobile communication server MCS transmits the ‘www.hongdong.co.kr’ information to a specific hosting server HS1˜HSn by way of the route server RS1 so that the corresponding mobile communication terminal A1˜An can connect to the corresponding homepage.

Hereinafter, a fifth embodiment of the present invention will be described in detail with reference to the accompanying drawings.

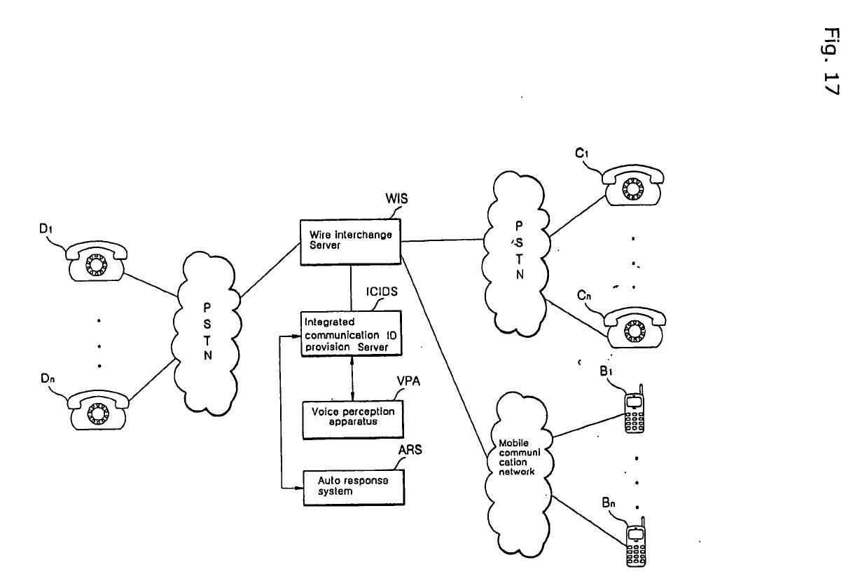

FIG. 17 is a block diagram illustrating a schematic configuration of a system for providing an integrated communication ID according to a fifth embodiment of the present invention.

Referring to this, the system for providing an integrated communication ID according to the fifth embodiment of the present invention can acquire from a specific wire telephone terminal D1˜Dn an integrated communication ID information of an unspecified third person and the user's various kinds of communication equipment information, homepage information, vehicle information, e-mail information, etc. opened by the user owning the integrated communication ID.

For this, an integrated communication ID provision server ICIDS is provided for managing integrated communication IDs allocated to respective users, managing directory information, i.e., the low-order information of the integrated communication Ids in relation with the wire interchange server WIS, and providing the corresponding directory information by judging which integrated communication ID of which information the user wants through voice perception.

Further, the user may connect immediately to wire telephone terminals D1˜Dn or mobile communication terminals B1˜Bn by utilizing the information acquired from the integrated communication ID provision server ICIDS.

Accordingly, a voice perception apparatus VPA is embedded in the integrated communication ID provision server ICIDS so as to judge which integrated communication ID the information desired by the caller belongs to by the caller voice perception, and an ARS apparatus ARS is linked thereto for receiving inputs of answers and various kinds of optional information. The voice perception apparatus and the ARS apparatus ARS are the same as the voice ID announcing apparatus VIDA explained in FIG. 13.

For this, it is preferred to allocate a specific telephone number (e.g., 150-150, . . . etc.) for connection use to the integrated communication ID provision server ICIDS so that the user can connect to the integrated communication ID provision server ICIDS through general wire telephone terminals D1˜Dn.

Accordingly, the user is enabled to connect to the integrated communication ID provision server ICIDS through general wire telephone terminals D1˜Dn. Since the telephone number for connection is linked with the ARS apparatus ARS, once a wire call connection is established, the integrated communication ID provision server ICIDS outputs the voice saying ‘enter an integrated communication ID in voice yon want to get information.’ through the ARS apparatus ARS.

When the user enters an integrated communication ID to be communicated with and a communication method in voice like, for example, ‘2pinetree’, through wire telephone terminals D1˜Dn, the integrated communication ID provision server ICIDS judges that the corresponding user is making a call to the home telephone number of the integrated communication ID ‘pinetree’ or is requesting an information on the corresponding home telephone number.

Then, the integrated communication ID provision server ICIDS outputs the voice so as to choose whether an immediate phone call or an information outputting is to be executed to the wire telephone terminal D1˜Dn side of the corresponding user. Preferably, if an immediate phone call is desired to be executed, number ‘1’ is pressed, or if only a telephone number information is desired to be outputted, number ‘2’ is pressed.

Consequently, according to the user's selection, a phone call is established by making a call connection to communication equipment (e.g., home wire telephone) having the corresponding integrated communication ID, or the connection number information of the communication equipment is outputted. Also, the homepage URL contained in the directory information, which is a low-order information of the corresponding integrated communication ID, and the e-mail information are guided very easily when opened to the public even if the user did not ask another user one by one by telephone, thereby making the use of information convenient.

The functions and operation of the thusly configured system for providing an integrated communication ID according to the fifth embodiment of the present invention will be described in detail with reference to the accompanying drawings.

Firstly, the user connects to the integrated communication ID provision server through general wire telephone terminals D1˜Dn. That is, the user is connected to the integrated communication ID provision server ICIDS through a telephone number for connection use allocated in advance to the integrated communication ID provision server ICIDS. Since the telephone number for connection is linked with the ARS apparatus ARS, once a wire call connection is established, the integrated communication ID provision server ICIDS outputs the voice saying ‘enter an integrated communication ID in voice yon want to get information.’ through the ARS apparatus ARS.

When the user enters an integrated communication ID to be communicated with and a communication method in voice like, for example, ‘2pinetree’, through wire telephone terminals D1˜Dn, the integrated communication ID provision server ICIDS judges that the corresponding user is making a call to the home telephone number of the integrated communication ID ‘pinetree’ or is requesting an information on the corresponding home telephone number.

Then, the integrated communication ID provision server ICIDS outputs the voice so as to choose whether an immediate phone call or an information outputting is to be executed to the wire telephone terminal D1˜Dn side of the corresponding user. Preferably, if an immediate phone call is desired to be executed, number ‘1’ is pressed, or if only a telephone number information is desired to be outputted, number ‘2’ is pressed.

Consequently, according to the user's selection, a phone call is established by making a call connection to communication equipment (e.g., home wire telephone) having the corresponding integrated communication ID, or the connection number information of the communication equipment is outputted.

Hereinafter, a sixth embodiment of the present invention will be described in detail with reference to the accompanying drawings.

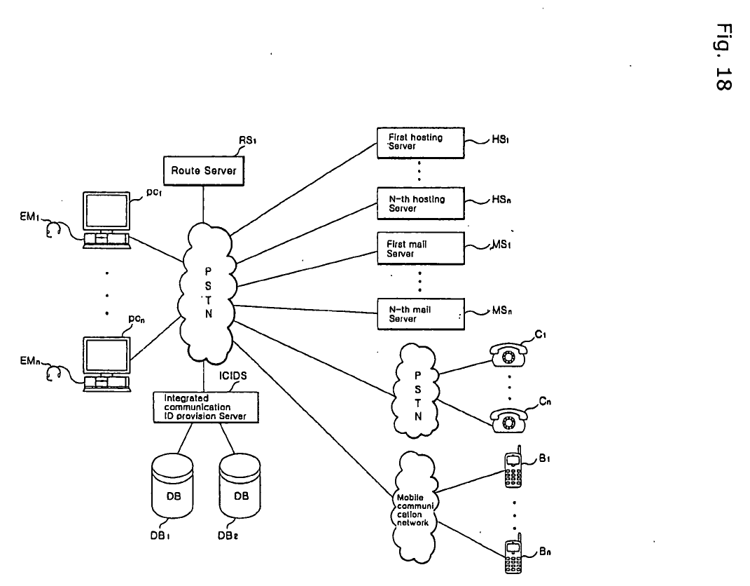

FIG. 18 is a block diagram illustrating a schematic configuration of a system for providing an integrated communication ID according to a sixth embodiment of the present invention.

Referring to this, the system for providing an integrated communication ID allows a caller to connect to various kinds of communication equipment of a specific integrated communication ID by utilizing a personal computer terminal PC1˜PCn. In the case that the user uses the personal computer terminal PC1˜PCn, the user connects to the URL allocated in advance and accessible to the integrated communication ID provision server ICIDS.

The integrated communication ID provision server ICIDS provides lower-order directory information for respective integrated communication IDs, such as the corresponding integrated communication ID owner's wire telephone number, facsimile number, homepage, e-mail, . . . and the like, to the web browser of the corresponding personal computer terminal PC1˜PCn.

The user selects any one of the lower-order directory information by utilizing the personal computer terminal PC1˜PCn, and connects to the homepage of the user owning the corresponding integrated communication ID according to whether to directly connect to the corresponding communication equipment or not. Also, the user can send e-mail to the corresponding user and connect in real time to general wire telephone terminals C1˜Cn and mobile communication terminals B1˜Bn over a PSTN network and a mobile communication network by a web phone.

The web phone is such a method in which an apparatus consisting of microphones EM1˜EMn is added to the personal computer terminal PC1˜PCn of the user to thereby be connected to a repeating apparatus through a data communication network. This is an already known art, so an explanation thereof will be omitted.

Meanwhile, in the system for providing an integrated communication ID according to the embodiment of the present invention, the integrated communication ID provision server ICIDS is connected to various kinds of communication interchange servers, and low-order information for respective integrated communication IDs, such as mobile communication terminal information, wire telephone terminal information, homepage information, e-mail information, vehicle information, pet dog number information, image data of children and the like, are scannably built into a database in the integrated communication ID provision server ICIDS. Thus, it is possible for an unspecified third person to inverse-scan information.

For instance, in the case that an unspecified third person wants to make a phone call to the owner of a specific vehicle information (Seoul 12 Mo 1234), the unspecified third person can connect to the integrated communication ID provision server ICIDS through mobile communication terminal A1˜An or wire telephone terminal C1˜Cn and acquire the mobile communication terminal information of the owner of the specific vehicle information (Seoul 12 Mo 1234) among the directory information opened to the public for respective integrated communication IDs, and is made connectable to the corresponding vehicle owner. Also as in the case that a pet dog number is perceived, the pet dog owner can be retrieved in the above manner.

In case of looking for the parents of a child by utilizing image information of the child, the inverse scanning of an integrated communication ID is made possible through an image comparator (not shown) added to the integrated communication ID provision server ICIDS. In this case, it is necessary that an unspecified third person picks up the image information of the child to transmit it to the integrated communication ID provision server. In recent times, there exists mobile communication terminal A1˜An with a video camera attached thereto, so it is possible to make a phone call to the parents of a specific child through such image pickup means. Further, also as in the case that the real name of a child had been registered, an unspecified third person can connect to the integrated communication ID provision server, enter in the corresponding real name, and then conduct a communication connection to the parents of the child of the real name. Even if there exist multiple people registered as the corresponding real name, the unspecified third person and the parents are able to look for the child more quickly.

Preferably, the directory information registered for respective integrated communication IDs in the integrated communication ID provision server ICIDS may include messenger IDs and account information. In case of messenger, the opening of information is conducted so that an unspecified third person can connect to a messenger through a wireless network or wire network. In case of mobile communication terminal A1˜An, a specific short messaging server can be executed by a messenger program of a user having a specific integrated communication ID. In order to add such messenger service to the integrated communication ID provision server ICIDS, the computer terminal IP address and ID of the corresponding user should be stored as the messenger information in a second database DB2 of the integrated communication ID provision server ICIDS in the form of a hidden information.

Meanwhile, in the case that account information is included as the directory information of an integrated communication ID, it can be said that the account information is prepared for performing various kinds of wireless internet banking, while the user, who is the owner of the corresponding integrated communication ID, does not remember his or her own account number but had registered it in the integrated communication ID provision server ICIDS. In this case, the account information is stored in the form of hidden information in the second database DB2 storing the directory information, and the account information contains the URL of the corresponding banking server.

Accordingly, if it is assumed that a number specifying account information is ‘9’ and an integrated communication ID desired to be connected is ‘pinetree’, the integrated communication ID provision server ICIDS provides the account information of the user having the corresponding integrated communication ID ‘pinetree and the URL of the banking server (not shown) of the corresponding account, thereby enabling to connect to the homepage capable of executing the internet banking of the corresponding banking organ. Also as in this case, a password or the like has to be entered to identify the user, and it is very convenient because the internet banking can be conducted even without remembering the account number.

Preferably, visual accounts storing multiple users' account information can be built inside the integrated communication ID provision server ICIDS. The visual accounts are linked with the banking server and receive only paying-in/paying-out data from the banking server and store the paying-in/paying-out data so that the user can confirm them. At this time, when the authentication of the user is achieved, the paying-in/paying-out information is opened only to the corresponding user while being kept closed to other people who are not authenticated.

In contrast with the above signaling system, a specific user is able to connect to the integrated communication ID provision server ICIDS to issue a paying-in/paying out command. In this case, it is possible to solve various security problems that are likely to occur when the user connects directly to a banking server by way of an added value network by utilizing mobile communication terminal A1˜An to generate various banking signals. This will be a help to reduce the processing capacity of mobile communication terminal A1˜An.

That is to say, when the user connects to the visual account of the integrated communication ID provision server ICIDS, enters the integrated communication ID of a recipient and enters an amount of money to be transferred, the integrated communication ID provision server ICIDS issues the user's paying-in/paying-out command to the corresponding banking server. In this case, the paying-in/paying-out command issued from the integrated communication ID provision server is encrypted in the integrated communication ID provision server ICIDS and transmitted to the banking server by way of an encrypted and authenticated added value network, thereby achieving a powerful security system. That is, it is possible to reduce the possibility of hacking that is likely to occur when the user directly connects to the banking server via a wireless web network.

Further, in the system for providing an integrated communication ID according to the embodiment of the present invention, the integrated communication ID provision server ICIDS plays the role of designating a connection route of data by being connected to various kinds of communication equipment or repeating apparatuses. Thus, data sent and received by mutual agreement of both users can be stored in the integrated communication ID provision server ICIDS. In this case, storage areas are allocated to respective integrated communication IDs in the database of the integrated communication ID provision server ICIDS and received and sent data can be stored according to the selection of the users. The size and storage time of the storage space areas are additive examples, so an explanation thereof will be omitted. Stored data commonly include character data, specific files, image data, moving image data, voice data and the like.

Additionally, with the mobile communication exclusive homepage with a relatively small data capacity being stored in the integrated communication ID provision server ICIDS, that homepage can be provided upon the connection of an unspecified third person.

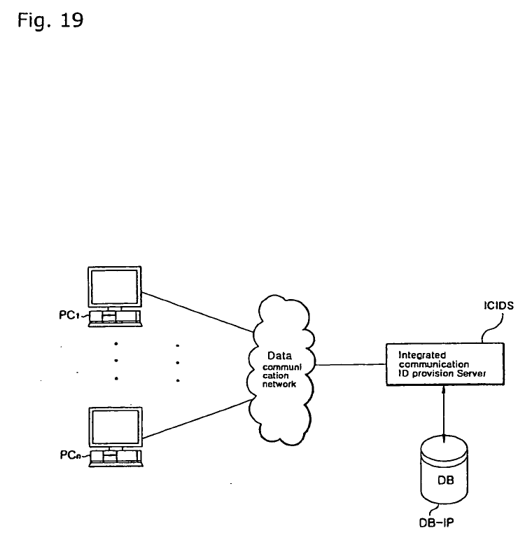

FIG. 19 is a block diagram illustrating a configuration in which an IP database is included in the system for providing an integrated communication ID according to the sixth embodiment of the present invention.

Referring to this, in the system for providing an integrated communication ID according to the sixth embodiment of the present invention, the registration and update processing for a basic integrated communication ID, a relational integrated communication ID (=friend integrated communication ID) and a local integrated communication ID can be conducted in the integrated communication ID provision server ICIDS, and a user can conduct an information updating and registration and a voice phone call to another user using VOIP in the integrated communication ID provision server ICIDS through an internet network.

Further, it is possible to retrieve the integrated communication ID of another user in a state of being connected to the integrated communication ID provision server ICIDS through the internet network.

For this, in the system for providing an integrated communication ID according to the sixth embodiment of the present invention, the integrated communication ID provision server ICIDS provides computer terminals PC1˜PCn of the corresponding user with an exclusive application that can be used by the user having an integrated communication ID, and individual IP addresses are allocated to the computer terminals PC1˜PCn of the corresponding user so that the application is easily operable. And, the integrated communication ID provision server ICIDS is prepared with an IP address database DB-IP capable of storing an IP address information linked with integrated communication IDs for respective users.

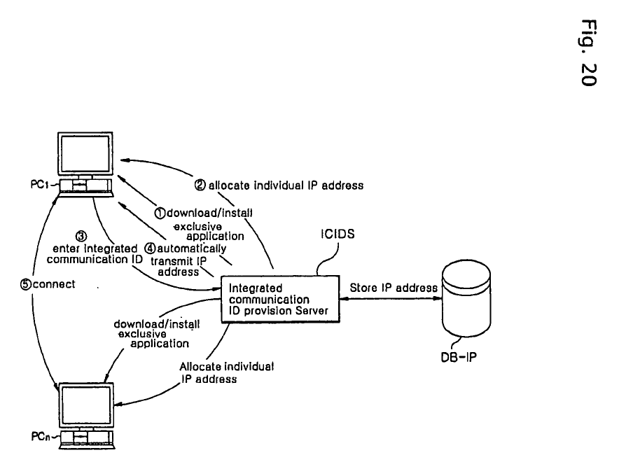

FIG. 20 is a view illustrating a web exclusive application installation and a data communication status using the application in the system for providing an integrated communication ID according to the sixth embodiment of the present invention.

Referring to this, in the system for providing an integrated communication ID according to the sixth embodiment of the present invention, it is possible to perform an automatic connection to the integrated communication ID provision server ICIDS and a connection to the owner of a desired integrated communication ID by utilizing an exclusive application installed at computer terminals PC1˜PCn of a user. Firstly, a certain unspecified user connects to the integrated communication ID provision server ICIDS, downloads an integrated communication ID exclusive application and installs it at computer terminals PC1˜PCn of the corresponding user.

This exclusive application is a program similar to a sort of messenger program, by which it is possible to establish a direct connection conveniently and transmit various kinds of files, with multiple users owning an integrated communication ID registered in the application in advance. Further, the registration, update and retrieval of information can be conducted in real time by connecting to the integrated communication ID provision server ICIDS by one-click button.

The user connects to the integrated communication ID provision server ICIDS to download and install the exclusive application. Simultaneously with the installation, the IP address of the computer terminal PC1˜PCn of the corresponding user is transmitted to the integrated communication ID provision server ICIDS, and the integrated communication ID provision server ICIDS allocates another IP address different from the above IP address to the computer terminal PC1˜PCn of the corresponding user. The newly allocated IP address is for easily classifying data in the integrated communication ID provision server ICIDS. The exclusive IP address is stored in the database in conjunction with the integrated communication ID.

If the user wants to connect to the computer terminal PC1˜PCn of another user having a specific integrated communication ID (e.g., ‘angel’) by utilizing the computer terminal (e.g., PC1), the integrated communication ID provision server ICIDS transmits the IP address of the linked computer terminal to the connection requesting computer terminal PC1 by utilizing the corresponding integrated communication ID (angel), thereby enabling a two-way connection.

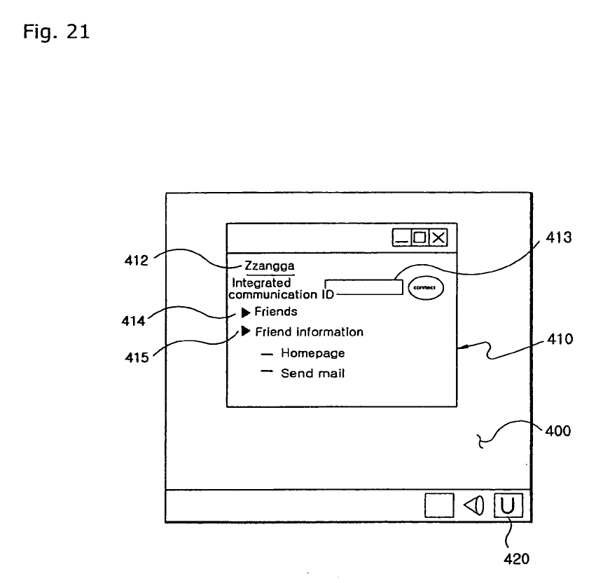

FIG. 21 is a view illustrating a soft copy status of the web exclusive application of the system for providing an integrated communication D according to the sixth embodiment of the present invention.

Referring to this, when the exclusive application illustrated in FIGS. 19 and 20 is installed at the computer terminal PC1˜PCn of a user, the exclusive application icon 420 is displayed on the tool bar at the lower end of a window screen.

When the user clicks the exclusive application icon 420, the application is driven to display a popup window 410 as shown in the drawing. On the popup window 410, the integrated communication ID (zzangga: 412) of the corresponding user is outputted and an input column 413 for a connection-desired integrated communication ID is soft copied.

Additionally, a friend group information 414 with registered integrated communication IDs and an information output column 415 for the corresponding integrated communication IDs are prepared on the lower end of the popup window 410. The information output column 415 is linked with homepage information so as to directly connect to the homepage for each individual registered integrated communication ID, and is linked with a send mail button for directly sending and receiving a short message or mail without a mail server.

Meanwhile, the system and method for providing an integrated communication ID according to the embodiment of the present invention are not limited to the above embodiments. It will be evident that various modifications and changes are made thereto without departing from the broader spirit and scope of the invention as set forth in the appended claims.

### INDUSTRIAL APPLICABILITY

The system and method for providing an integrated communication ID provide an individual integrated communication ID so as to access to various communication equipment numbers, a homepage URL, a vehicle number, a pet dog number, a children's real name, an image information of children and an account information enabling the internet banking without a user's confirming the information, thereby contributing to the convenience between users and to the activation of communication interface. In addition, it is possible to carry out an inverse scanning based on a variety of information, thus enabling real time communication interface with an owner. Further, it is very convenient since various information opened to the public according to an individual integrated communication ID is readable by an unspecified third person. Further, there is no need to remember a variety of numbers, URLs, e-mail IDs, messenger IDs and the like in the flood of information.

What is claimed is:

1. A system for providing an integrated communication ID, comprising:
a caller terminal which allows an unspecified third person perceiving an integrated communication ID of a callee to generate various communication signals and input signals;
an integrated communication ID provision server which stores various communication target connection numbers, vehicle number, children's real name and the like as directory information, provides a single individual integrated communication ID commonly designating the above information to manage the same so as to provide other connection number and readable information to an unspecified third person perceiving the integrated communication ID, and designates a connection route in response to a route query request of various kinds of interchange servers; and
an interchange server which is connected so as to able to scan the database of the integrated communication ID provision server, executes a query request for a route to the integrated communication ID provision server according to a connection request signal from the caller terminal and executes a connection attempt to a connection target terminal according to an answer signal.

2. The system of claim 1, wherein the communication target connection number is a mobile communication terminal, a facsimile, a wire telephone, a homepage, e-mail, a web phone, a messenger and the like.

3. The system of claim 1, wherein the caller terminal is communication equipment capable of voice communication and data communication, including a mobile communication terminal, a wire telephone terminal and a personal computer terminal.

4. The system of claim 1, wherein the caller terminal has inside a code conversion algorithm installed therein for automatically converting an integrated communication ID composed of multi-language characters entered by a user into a connection code of a numeric string receivable by a switch and a base station.

5. The system of claim 4, wherein the code conversion algorithm is either the allocation of a connection code for respective characters or the allocation of a connection code for respective words.

6. The system of claim 1, wherein the interchange server includes at least one of a base station and a switch which are a repeater of a wireless communication network, an intelligent network switch, a local switch which is a repeater of a wire communication network, a toll switch, a connection switch, various route servers and gateways which are repeaters of wire/wireless web networks, and a WAP gateway.

7. The system of claim 1, wherein the integrated communication ID provision server further comprises a database scannably storing personal information of a user who is allocated an integrated ID, integrated communication ID information allocated individually to respective users and open information opened by the user such as various communication equipment and homepage information, e-mail information, vehicle information, children's real name and the like.

8. The system of claim 1, wherein an information display number individually representing various information (cellular phone number, home telephone number, office telephone number, homepage, e-mail) stored in the directory information for respective integrated communication IDs is predetermined to be a characteristic number or the like between the integrated communication ID provision server and the user.

9. The system of claim 1, wherein the integrated communication ID is composed of at least one of various kinds of characters, specific characters, numeric characters, various kinds of patterns and image data.

10. The system of claim 1, wherein, in the case that the caller terminal is a mobile communication terminal, an integrated communication ID information and character data to be transmitted are simultaneously entered into the same screen so that the integrated communication ID provision server can recognize them separately.

11. The system of claim 10, wherein a specific character or symbol representing the beginning of a text is interposed between the integrated communication ID information and the character data.

12. The system of claim 1, wherein the integrated communication ID includes a basic integrated communication ID allocated individually, a relational integrated communication ID allocated redundantly in unit of groups and a local integrated communication ID allocated redundantly according to a regional unit.

13. The system of claim 1, wherein the caller terminal has the basic input mode for entering a basic integrated communication ID, the relational integrated communication ID input mode and the local integrated communication ID input mode all individually and optionally configured.

14. The system of claim 1, wherein the integrated communication ID provision server has inside a database configured therein to have a structure in which relational integrated communication ID data and local integrated communication ID data are linked with each other based on the database storing basic integrated communication IDs.

15. A method for providing an integrated communication ID individually allocated to enable a real time connection and a real time information reading by commonly designating a connection information of various connectable communication means and a various opened information by means of a server providing the integrated communication ID and an interchange server, the method comprising the steps of:
multiple users' connecting to a PC or the integrated communication ID provision server;
a user' registering an individual integrated communication ID and its low-order information;
performing communication connection by utilizing an integrated communication ID of another user; and
performing the reading of the opened low-order information by utilizing an integrated communication ID of another user.

16. The method of claim 15, wherein the step of a user' registering an individual integrated communication ID and its low-order information comprises the steps of:
multiple users' connecting to a PC or the integrated communication ID provision server;
retrieving whether an integrated communication ID desired to be registered by the user is registered or not;
requesting for the registration of the corresponding integrated communication ID if the corresponding integrated communication ID is not redundant; and
selecting which information to be opened among the directory information (home telephone number, office telephone number, homepage information, facsimile number, e-mail information, vehicle information, children's real name and the like) which is the low-order information of the registered integrated communication ID.

17. The method of claim 15, wherein the step of performing communication connection by utilizing an integrated communication ID of another user comprises the steps of:
a certain user's attempting a connection by entering a connection-desired integrated communication ID of a specified third person and an information representing the communication target by utilizing a communication terminal;
the interchange server's scanning the information issued from the communication terminal of the corresponding user in conjunction with the integrated communication ID provision server;
the interchange server's executing a query request for the corresponding integrated communication ID to the integrated communication ID provision server;
the integrated communication ID provision server's providing the corresponding integrated communication ID and a connectable communication equipment connection number based on the communication target information; and
the interchange server's receiving the communication equipment connection number and making a call connection between both parties.

18. The method of claim 15, further comprising the step of sending a change information to the registrant registered in the integrated communication ID provision server according to the user's selection if the integrated communication ID of the corresponding user is changed.

19. The method of claim 15, further comprising the steps of:
a user's entering an integrated communication ID of a call connection target person by utilizing a wire/wireless terminal;
converting the integrated communication ID of the call connection target person by utilizing a code conversion algorithm installed at the wire/wireless terminal of the corresponding user;
generating a frequency signal corresponding to the connection code;
receiving the frequency signal via a switch or a local/toll switch;
transmitting the corresponding frequency to an intelligent network switch;
the intelligent network switch's restoring the connection code by utilizing the frequency information to transmit the same to the integrated communication ID provision server;
extracting the actual telephone number of the user having the corresponding connection code from the integrated communication ID provision server;
transmitting the actual telephone number to the intelligent network, the switch and a base station to attempt a call connection;
converting the connection code to restore the integrated communication ID of the originating user; and
soft copying the restored integrated communication ID of the originating user.

20. The method of claim 19, wherein the step of extracting the actual telephone number of the connection target person the integrated communication ID provision server further comprises the step of combining a specific phrase registered by the originating user so as to be included in a call connection data packet along with the integrated communication ID of the originating user.

21. A method for providing an integrated communication D, which has various communication equipment and its low-order information registered and further comprises a voice ID announcing apparatus consisting of a voice perception apparatus and an ARS apparatus, comprising the steps of
executing a call connection to the integrated communication ID provision server by utilizing a short-cut key or a representative telephone number;
entering an integrated communication ID in voice;
converting voice data into character data and extracting the corresponding connection code and the actual telephone number;
transmitting the connection code and the actual telephone number to a repeater; and
the repeater's establishing a call connection between the terminal of both users.

22. A system for providing an integrated communication ID, comprising:
a caller wire telephone terminal for allowing an unspecified third person perceiving the integrated communication ID of a callee to generate various kinds of communication signals and input signals;
an integrated communication ID provision server which provides an integrated communication ID to the callee, provides opened information of the corresponding integrated communication ID to the caller, who is an unspecified third person, as the low-order information of the integrated communication ID, and designates a connection route so as to enable a real time communication connection, and which is constructed of a voice perception apparatus and a voice ID announcing apparatus capable of recognizing an integrated communication ID and generating various answer signals;
an interchange server which executes a signal interchanging so as to be able to transmit data to the integrated communication ID provision server according to a connection request signal from the wire telephone terminal; and
a callee terminal which executes a call connection by way of the integrated communication ID provision server according to the integrated communication ID information entered via the caller wire telephone terminal and according to a request for connection to the communication equipment target.

23. The system of claim 1, wherein the integrated communication ID provision server further comprises a database with storage areas allocated to respective integrated communication Ids so as to store various data sent and received between a caller terminal and a callee terminal.

24. The method of claim 15, further comprising the steps of:
an unspecified third person's connecting to the integrated communication ID provision server via various kinds of terminals;
entering a specific directory information;
inverse-scanning the telephone terminal of the owner of the corresponding directory information;
attempting a call connection to the owner of the corresponding directory information so as to enable a communication connection to the owner.
